(19) United States
(12) Patent Application Publication
(10) Pub. No.: US 2003/0182129 A1
(43) Pub. Date: Sep. 25, 2003

(54) Dialog system and dialog control system

(76) Inventors: Hirohide Ushida, Nagoya-shi (JP); Hiroshi Nakajima, Kyoto-shi (JP); Hiroshi Daimoto, Yawata-shi (JP)

Correspondence Address: ROSENTHAL & OSHA L.L.P., Suite 2800, 1221 McKinney Street, Houston, TX, 77010, US

(21) Appl. No.: 10/389,699

(22) Filed: Mar. 14, 2003

(30) Foreign Application Priority Data
Mar. 14, 2002 (JP) 070369/2002

(51) Int. Cl. G10L 21/00

(52) U.S. Cl. 704/270.1; 704/270

(57) ABSTRACT

It is an object to carry out an operation in a voice by using a voice recognition, a contact input, a voice output and a screen display together by means of a terminal having a low performance. A dialog system is constituted to have a voice device (3) for transmitting voice information, a screen device (8) for transmitting screen information and a dialog control device (7) for transmitting/receiving information to/from the devices (3) and (8). The devices (3), (7) and (8) are connected to a public circuit switched network (1) and a network (4), respectively. A voice terminal (2) is connected to the circuit (1) and a screen terminal (5) is connected to the network (4) so that a communication can be carried out between the terminal (2) and the device (3) and between the terminal (5) and the device (8), and the mutual communication of the devices (3) and (8) is controlled by the dialog control device (7). The voice information and the screen information are transmitted/received between the terminal (2) and terminal (5), respectively in such a manner that a voice input and a contact input can be executed together. The voice terminal (2) and the screen terminal (5) are constituted by different terminals or the same user terminal.

### BACKGROUND OF THE INVENTION

1. Field of the Invention

The present invention relates to a dialog system and a dialog control device, and more particularly a suitable device for a voice recognizing system for causing a user and a machine to carry out a dialog by using a voice and a screen together.

2. Description of the Background Art

Conventionally, there has been known a dialog system comprising a voice recognition, a contact input, a voice output and a screen display respectively and serving to carry out a dialog between a user for handling a terminal and a machine by using a voice and a screen together. The contact input is an input to be executed by a contact of a human body with a tool, for example, a keyboard, a touch panel, a pointing device, a numeric keypad or the like. In the dialog system according to the conventional art, moreover, a terminal owned by a user comprises a voice recognizing section, a voice control section and an information presenting section, for example.

The dialog system to be utilized in an internet environment will be described below with reference to the drawing. FIG. 11 shows the structure of the dialog system according to the conventional art.

As shown in FIG. 11, in the dialog system according to the conventional art, a user terminal 102 to be operated by a user, a voice recognizing dictionary server 103 and a Web server 104 are connected to an internet 101. Moreover, the user terminal 102 has a voice control section 102a, a voice recognizing section 102b and an information presenting section 102c. The user terminal 102 is further provided with a contact input section, for example, a pointing device such as a mouse, a keyboard or the like, which is not shown.

The user to operate the user terminal 102 uses the voice recognition of the voice recognizing section 102b, the contact input of the contact input section, the voice output of the voice control section 102aand the screen display of the information presenting section 102c together thereby inputting or acquiring information.

The dialog system according to the conventional art which has such a structure produces an advantage that a voice recognizing dictionary can be switched for each HTML (Hyper Text Markup Language) document by using the HTML document and a control pattern file.

More specifically, it is possible to switch the voice recognizing dictionary by specifying the voice recognizing dictionary to be used in the HTML document and the HTML document to be presented next for each recognizing vocabulary in the control pattern file.

However, the dialog system according to the conventional art has the following problem.

More specifically, a high performance central processing unit (a processor (CPU)) and a mass memory are required for executing a voice recognition by setting several hundred thousands large scale recognizing vocabularies to be an object. For this reason, in a method of executing the voice recognition through a terminal as in the dialog system described above, a cost for manufacturing a terminal having a high performance CPU and a mass memory is increased.

As a specific example, the execution of the voice recognition related to a large quantity of vocabularies by using a cell phone terminal considerably increases the manufacturing cost of a cell phone terminal body, resulting in a great increase in a selling price. For this reason, it is very difficult to implement the voice recognition using the cell phone terminal and utilization in a movement environment is hindered.

In a dialog using a voice, moreover, it is necessary to control a voice recognition and a voice output depending on the situation of the dialog.

More specifically, it is necessary to carry out control in the case in which a voice given by a user cannot be recognized or control as to whether a dialog given by the user is accepted at time of the output of a voice guidance by a terminal device. In the dialog system described above, however, the HTML document is used as a control language. Therefore, it is hard to execute necessary control for a dialog using a voice.

More specifically, in the conventional dialog system, a recognizing vocabulary is detected and an HTML document corresponding to the recognizing vocabulary is acquired from a server. In the case in which the recognizing vocabulary cannot be detected, however, it is impossible to acquire the HTML document. Consequently, a dialog is stopped when the recognition cannot be carried out. Moreover, it is very hard to represent, in the HTML document, control information as to whether a dialog given by the user is accepted.

Accordingly, it is an object of the present invention to provide a dialog system and a dialog control device wherein a terminal which does not need to have a high performance and a high function and has only the same performance as that of a cell phone terminal can use a voice recognition, a contact input, a voice output and a screen display together and can control an operation (a dialog processing) in a voice by using them.

### SUMMARY OF THE INVENTION

In order to solve the problems, a firs aspect of the present invention is directed to a dialog system comprising:

a voice information providing device constituted to output voice information;

a screen information providing device constituted to output screen information; and

a dialog control device having constituted to transmit/receive electronic information to/from the screen information providing device and the voice information providing device,

a first communicating terminal which is commutable to at least the screen information providing device and a second communicating terminal commutable to at least the voice information providing device being constituted to be connectable,

the screen information providing device having a recording section for recording first electronic information to be transmitted to the first communicating terminal constituted to display visual information and second electronic information to be used in the dialog control device, and being constituted to execute at least one of a processing of transmitting the first electronic information to the fist communicating terminal and a processing of transmitting the second electronic information to the dialog control device based on information received from the first communicating terminal or the dialog control device,

the voice information providing device being constituted to transmit, to the second communicating terminal, voice information based on information for a voice dialog generated by the dialog control device and constituted to recognize the received voice information to generate a voice recognition result based on the information for a voice dialog, thereby transiting the same result of the dialog control device, and

the dialog control device being constituted to generate the information for a voice dialog and to transmit the same information to the voice information providing device based on the second electronic information upon receipt of the second electronic information and constituted to transmit information related to the voice recognition result to the screen information providing device based on the second electronic information upon receipt of the voice recognition result from the voice information providing device.

In the first aspect of the present invention, typically, the screen information providing device, the voice information providing device and the dialog control device are constituted to be mutually connectable through a network such as a telephone circuit switched network, an internet or a local area network (LAN), and the first communicating terminal and the second communicating terminal are constituted to be connectable through the network.

Furthermore, a second aspect of the present invention is directed to a dialog system in which a screen information providing device and a voice information providing device are connected to each other,

the screen information providing device having a recording section capable of recording first electronic information to be transmitted to a first communicating terminal capable of displaying visual information and second electronic information to be used in the voice information providing device and being constituted to execute at least one of a processing of transmitting the first electronic information to the first communicating terminal based on information received from the first communicating terminal or the voice information providing device upon receipt of the same information and a processing of transmitting the second electronic information to the voice information providing device, and

the voice information providing device being constituted to transmit voice information based on the second electronic information to a second communicating terminal capable of outputting a voice upon receipt of the second electronic information from the screen information providing device and being constituted to recognize voice information the received voice information based on the second electronic information to generate a voice recognition result upon receipt of the voice information from the second communicating terminal and to transmit the voice recognition result to the screen information providing device.

In the first and second aspects of the present invention, it is preferable that the first communicating terminal and the second communicating terminal should be constituted by the same terminal in consideration of the case of use in a cell phone, a PHS or the like which can be connected to a network such as an internet.

In the second aspect of the present invention, typically, the screen information providing device and the voice information providing device are constituted to be mutually connectable through a network, and the first communicating terminal or the second communicating terminal is constituted to be connectable through the network.

Moreover, a third aspect of the present invention is directed to a dialog system in which a screen information providing device, a dialog control device and a voice recognizing device are mutually connected and a communicating terminal is constituted to be connectable,

the screen information providing device having a recording section capable of recording first electronic information to be transmitted to the communicating terminal and second electronic information to be used in the dialog control device, and being constituted to execute at least one of a processing of transmitting the first electronic information to the communicating terminal and a processing of transmitting the second electronic information to the dialog control device based on the information received from the communicating terminal or the dialog control device,

the dialog control device generating information for a voice dialog based on the second electronic information upon receipt of the second electronic information from the screen information providing device and transmitting the information for a voice dialog to the communicating terminal and transmitting information about a result recognition result to the screen information providing device based on the second electronic information upon receipt of the voice recognition result from the communicating terminal, and

the voice recognizing device being constituted to receive voice information from the communicating terminal, recognize the received voice information, to generate a voice recognition result and to transmits the voice recognition result to the communicating terminal.

In the third aspect of the present invention, typically, the communicating terminal is constituted in such a manner that the first electronic information and information obtained by processing the first electronic information can be output upon receipt of the first electronic information from the screen information providing device,

contact input information based on the first electronic information can be transmitted to the screen information providing device when the contact input is carried out,

an input of a voice or an output of the voice can be controlled based on the information for a voice dialog upon receipt of the information for a voice dialog from the dialog control device,

the voice can be transmitted to the voice recognizing device based on the information for a voice dialog when the input of the voice is carried out, and

information about the voice recognition result can be transmitted to the dialog control device based on the information for a voice dialog upon receipt of the voice recognition result from the voice recognizing device.

In the first or third aspect of the present invention, furthermore, it is preferable that the dialog control device should be constituted to generate information for a voice dialog based on the second electronic information and the voice recognition result upon receipt of the voice recognition result.

Moreover, a fourth aspect of the present invention is directed to a dialog system constituted by connecting a screen information providing device to a voice recognizing device and constituted such that a communicating terminal capable of communicating with the screen information providing device and the voice recognizing device can be connected thereto,

the screen information providing device has a recording section capable of recording first electronic information to be transmitted to the communicating terminal and second electronic information to be used in the voice recognizing device,

the first electronic information and the second electronic information are constituted to be transmitted to the communicating terminal based on information received from the communicating terminal, and

the voice recognizing device is constituted to recognize voice information received from the communicating terminal and to generate a voice recognition result of the voice information and is constituted to transmit the voice recognition result to the communicating terminal.

In the fourth aspect of the present invention, typically, the communicating terminal is constituted in such a manner that the first electronic information or information obtained by processing the first electronic information can be displayed upon receipt of the first electronic information from the screen information providing device, contact input information can be transmitted to the screen information providing device based the first electronic information when the contact input is carried out, an input of a voice and an output of the voice can be controlled based on the second electronic information upon receipt of the second electronic information from the screen information providing device, voice information of a voice can be transmitted to the voice recognizing device based on the second electronic information when the voice is input, and information about a voice recognition result can be transmitted to the screen information providing device based on the second electronic information upon receipt of the voice recognition result from the voice recognizing device.

In the fourth aspect of the present invention, typically, the screen information providing device and the voice recognizing device are connected to each other through a network, and the communicating terminal is constituted to be commutable with the screen information providing device and the voice recognizing device through the network.

Furthermore, a fifth aspect of the present invention is directed to a dialog control device comprising:

first receiving means for receiving electronic information transmitted from a first electronic computer connected to a network;

generating means for processing the electronic information to generate information for a voice dialog;

first transmitting means for transmitting the information for a voice dialog to a second electronic computer connected to the network and constituted to execute a voice dialog processing;

second receiving means for receiving a voice recognition result generated by a voice dialog processing executed in the second electronic computer; and

second transmitting means for transmitting information about the voice recognition result to the first electronic computer based on the voice recognition result or the electronic information.

In the fifth aspect of the present invention, in order to achieve a reduction in a space and a simplification in the device, typically, the first transmitting means and the second receiving means are constituted by the same first transmitting/receiving means, and the second transmitting means and the first receiving means are constituted by the same second transmitting/receiving means.

In the fifth aspect of the present invention, it is preferable that the generation of the information for a voice dialog can be executed based on the voice recognition result.

Moreover, a sixth aspect of the present invention is directed to a dialog system in which a communicating terminal having a user interface of a contact input, a voice input, a screen display and a voice output can be connected, comprising:

means for receiving electronic information based on the contact input transmitted through the communicating terminal;

means for receiving voice information based on the voice input transmitted through the communicating terminal;

means for transmitting electronic information to be used in the screen display to the communicating terminal;

means for transmitting voice information to be used in the voice output to the communicating terminal, and

means for changing electronic information to be used in the screen display or voice information to be used in the voice output corresponding to electronic information based on the contact input or voice information based on the voice input.

Furthermore, a seventh aspect of the present invention is directed to a dialog system which is constituted in such a manner that a first communicating terminal having a user interface of a contact input and a screen display can be connected and a second communicating terminal having a user interface of a voice input and a voice output can be connected, the dialog system comprising:

means for receiving electronic information based on the contact input which is transmitted through the first communicating terminal;

means for receiving voice information based on the voice input which is transmitted through the second communicating terminal;

means for transmitting electronic information to be used in the screen display to the first communicating terminal;

means for transmitting voice information to be used in the voice output to the second communicating terminal; and

means for changing voice information to be used in the electronic information based on the contact input or the voice information based on the voice input.

In the first, second and sixth aspects of the present invention, in order to cause the first communicating terminal to correspond to the second communicating terminal in the case in which a user uses the first communicating terminal and the second communicating terminal, typically, a first user identifier is contact input and transmitted from the first communicating terminal, a second user identifier is transmitted from the second communicating terminal, and the first user identifier is compared with the second user identifier so that the first communicating terminal can correspond to the second communicating terminal.

In the first, second and sixth aspects of the present invention, in order to cause the first communicating terminal to correspond to the second communicating terminal in the case in which a user uses the first communicating terminal and the second communicating terminal, typically, when the second communicating terminal is connected to the dialog system, first code number data are automatically generated and transmitted to the second communicating terminal in the dialog system, when the first code number data are output in a voice in the second communicating terminal and the first communicating terminal is then connected to the dialog system, second code number data are contact input from the first communicating terminal and are transmitted to the dialog system, and the first code number data are compared with the second code number data so that the first communicating terminal can correspond to the second communicating terminal in the dialog system.

In the first, second and sixth aspects of the present invention, in order to cause the first communicating terminal to correspond to the second communicating terminal in the case in which a user uses the first communicating terminal and the second communicating terminal and to more enhance a security, typically, when the first communicating terminal is connected to the dialog system, first code number data are automatically generated and transmitted to the first communicating terminal in the dialog system, when the first code number data are output on a screen in the first communicating terminal and the first communicating terminal is then connected to the dialog system, second code number data are transmitted from the second communicating terminal to the dialog system, and the first code number data are compared with the second code number data so that the first communicating terminal can correspond to the second communicating terminal in the dialog system.

In the first, second and sixth aspects of the present invention, in order to more simply cause the first communicating terminal to correspond to the second communicating terminal in the case in which a user uses the first communicating terminal and the second communicating terminal, typically, the first communicating terminal can be connected to a first network to which at least a screen information providing device and the second communicating terminal can be connected to a second network having a plurality of base stations which can communicate with the second communicating terminal and record positional information respectively, and when the second communicating terminal communicates with a first base station and any communicating terminal which is communicating other than the second communicating terminal is not present in the first base station and when the first communicating terminal is connected to the first network, the first communicating terminal can correspond to the second communicating terminal.

According to the dialog system and the dialog control system in accordance with the present invention which has the structure described above, when a terminal operation in a voice is to be executed by using the first communicating terminal and the second communicating terminal or a composite communicating terminal, a voice recognition processing is executed on the outside of the terminals. Consequently, it is possible to execute the voice recognition processing without applying a great load to the first communicating terminal and the second communicating terminal.

### BRIEF DESCRIPTION OF THE DRAWINGS

FIG. 1 is a block diagram showing a dialog system according to a first embodiment of the present invention and a voice terminal and a screen terminal which are to be connected to the dialog system,

FIG. 2 is a block diagram showing a dialog control device according to the first embodiment of the present invention,

FIG. 3 is a block diagram for explaining the correspondence of the dialog system according to the first embodiment of the present invention and the voice terminal and the screen terminal which are connected to the dialog system,

FIG. 4 is a program showing an example of document data for dialog control according to the first embodiment of the present invention,

FIG. 5 is a program showing the rest of the example of the document data for dialog control in FIG. 4,

FIG. 6 is a flowchart showing a dialog control processing to be carried out by the dialog control device according to the first embodiment of the present invention,

FIG. 7 is a block diagram showing a screen information providing device according to the first embodiment of the present invention,

FIG. 8 is a block diagram showing a dialog system according to a second embodiment of the present invention and a voice terminal and a screen terminal which are connected to the dialog system,

FIG. 9 is a block diagram showing a screen information providing device according to the second embodiment of the present invention,

FIG. 10 is a block diagram showing a dialog system according to a third embodiment of the present invention and a user terminal connected to the dialog system, and

FIG. 11 is a block diagram showing a dialog system according to the conventional art and a user terminal connected to the dialog system.

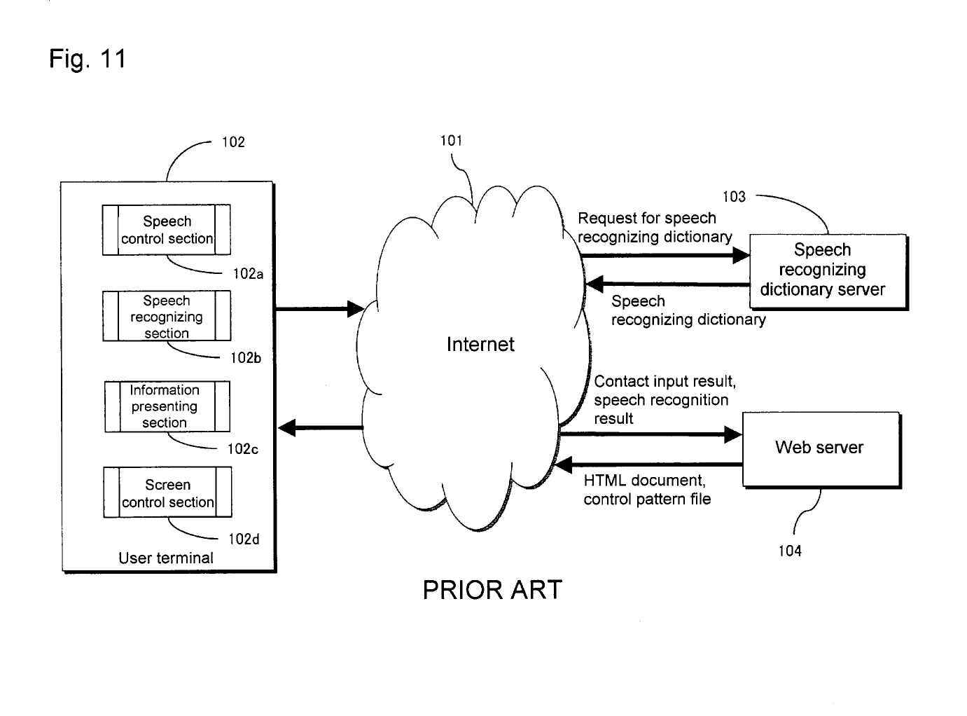

### DESCRIPTION OF THE PREFERRED EMBODIMENTS

Preferred embodiments of the present invention will be described below with reference to the drawings. In all the drawings of the following embodiments, the same or corresponding portions have the same reference numerals.

First Embodiment

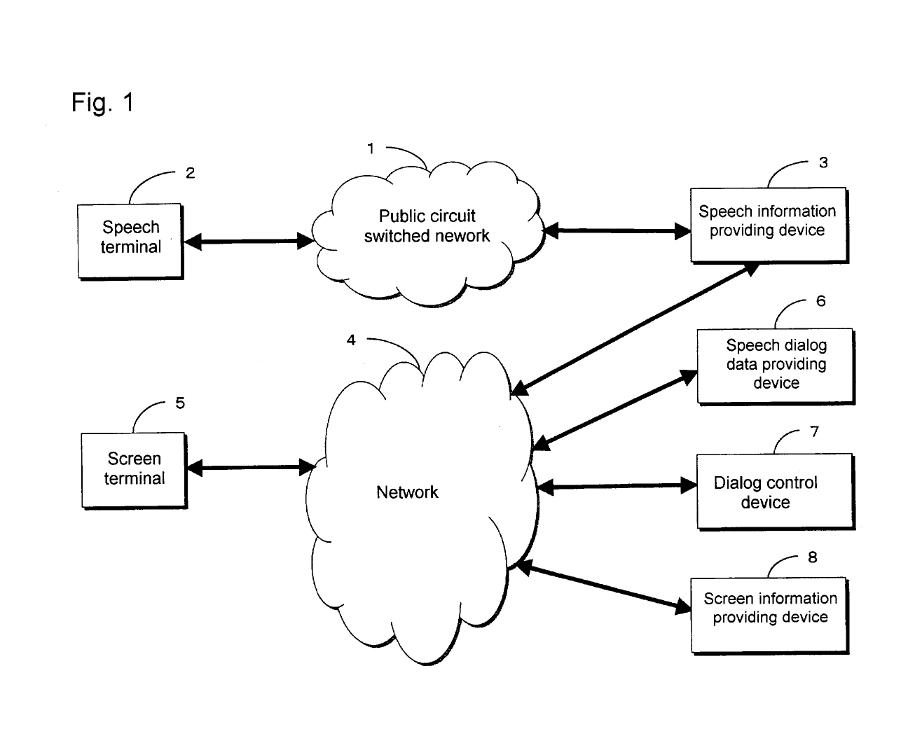

First of all, a dialog system according to a first embodiment of the present invention will be described. FIG. 1 is a dialog system according to the first embodiment and a voice terminal and a screen terminal which are connected to the dialog system.

As shown in FIG. 1, in a voice recognizing dialog system according to the first embodiment, a voice terminal 2 and a voice information providing device 3 are connected to a public circuit switched network 1 constituted by a circuit network such as a telephone circuit. In the dialog system, moreover, a screen terminal 5, a voice information providing device 3, a voice dialog data providing device 6, a dialog control device 7 and a screen information providing device 8 are connected to a wide area network 4 such as an internet.

The voice terminal 2 and the screen terminal 5 are terminals to be owned and used by the user side, and the voice information providing device 3, the voice dialog data providing device 6, the dialog control device 7 and the screen information providing device 8 are provided on the dialog system side.

The voice terminal 2 is a communicating terminal having means for inputting/outputting a voice of a cell phone, a PHS (Personal Handy phone System), a PDA (Personal Digital Assistant), a personal computer (PC) or the like, for example.

The voice terminal 2 has such a structure that a voice signal to be a voice generated by a user himself (herself) and a tone dial (Dial Tone Multi Frequency, DTMF) can be input and a voice signal sent from the voice information providing device 3 can be input through the public circuit switched network 1.

Moreover, the voice terminal 2 has such a structure that a voice signal can be output, and the voice signal is supplied to the voice information providing device 3 through the public circuit switched network 1. Furthermore, an audible voice can be output from the voice terminal 2 to the user.

In the case in which a voice or a DTMF is input from the user to the voice terminal 2 thus constituted, the voice or the DTMF is first converted into a voice signal and the voice signal is then transmitted to the voice information providing device 3 through the public circuit switched network 1. On the other hand, in the case in which the voice terminal 2 receives the voice signal from the voice information providing device 3, the voice terminal 2 reconstitutes the received voice signal into a voice and outputs the voice from a speaker (not shown) provided in the voice terminal 2. The user of the voice terminal 2 can hear the voice output from the speaker, thereby recognizing voice information.

The screen terminal 5 owned and used b the user is constituted by a communicating terminal having at least screen display means for displaying a GUI screen such as a cell phone, a PHS, a PDA or a PC and contact input means for accepting a contact input from the user (both of which are not shown). The contact input is an input to be carried out by causing the user to directly touch input means in a numeric key pad, a keyboard, a touch panel, a pointing device or the like, and can be implemented by hardware or software.

The screen terminal 5 has such a structure that the user can input text information such as a character and pointing information through a contact input, and can input, through the network 4, electronic information to be displayed on a screen which is transmitted from the screen information providing device 8, for example, an HTML document or the like.

Moreover, the screen terminal 5 has such a structure that a universal resource indicator (URI), input information input by the user through a contact input and an identifier (a user ID) for recognizing the screen terminal 5 can be output. The URI, the input information and the user ID are supplied to the screen information providing device 8 through the network 4. Furthermore, the screen terminal 5 has such a structure that screen information which can be recognized by the user can be output.

In the screen terminal 5 thus constituted, a session management is carried out through a Cookie together with the screen information providing device 8. Since the Cookie is included in the user ID, the screen information providing device 8 can identify the screen terminal 5.

In the case in which the input information and the URI are input from the user through the contact input, the screen terminal 5 converts these input information and URI into signals and then transmits the same signals to the screen information providing device 8 through the network 4. On the other hand, in the case in which the screen terminal 5 receives the electronic information from the screen information providing device 8, the screen terminal 5 analyzes the electronic information thus received and displays the same information as an image on a screen. The user of the voice terminal 2 can see the image displayed on the screen, thereby recognizing image information on the screen.

Next, the voice information providing device 3 is constituted to have at least VoiceXML analysis executing means for executing the analysis of “voice XML (VoiceXML)” to be a language to be used for voice recognition, voice recognizing means and voice synthesizing means. The VoiceXML analysis executing means, the voice recognizing means and the voice synthesizing means can also be provided in the same computer or different computers.

In the VoiceXML analysis executing means, generation is carried out for each voice terminal 2 to be connected and a session management is carried out through the Cookie together with the dialog control device 7. The Cookie is caused to include a code number so that the voice information providing device 3 and the dialog control device 7 can mutually correspond to the use of the voice terminal 2.

More specifically, in the VoiceXML analysis executing means, first of all, the analysis of a VoiceXML document is executed. In the case in which the VoiceXML document received at this time has a description of the execution of a voice recognition, a request for the recognition is sent to the voice recognizing means to acquire the result of the recognition. The result of the recognition thus acquired is transmitted to the dialog control device 7. Next, a recognition grammar is acquired from the location of the recognition grammar described in the VoiceXML document. In the case in which the VoiceXML document received at this time has a description of the execution of a voice synthesis, a request for the synthesis is given to the voice synthesizing means to acquire a result of the synthesis. Subsequently, the VoiceXML analyzing means converts the result of the synthesis thus acquired into a voice signal and then transmits the same voice signal to the voice terminal 2. In the case in which the VoiceXML document thus received has a description of the output of a file for a voice guidance, the file for the voice guidance is acquired from a location which is described. Thereafter, the contents of the file for the voice guidance thus acquired are converted into a voice signal and the voice signal is transmitted to the voice terminal 2.

In the case in which the VoiceXML document has a description of the acquirement of the VoiceXML document, a request for the VoiceXML document is given to a location specified by the URI.

Upon receipt of a breaking instruction signal from the dialog control device 7, moreover, a processing is carried out in the following procedure. The execution of the VoiceXML, the voice recognition and the output of a voice signal are halted. A request for the URI of a new VoiceXML document is given to the dialog control device 7. The URI is specified in the VoiceXML document which is transmitted to the voice information providing device 3 immediately before.

In the processing of the voice recognizing means, moreover, a voice recognition is first carried out at a request given from the VoiceXML analysis executing means and the result of the recognition is returned to the VoiceXML analysis executing means.

On the other hand, in the voice synthesizing means, text information is converted into voice data at a request given from the VoiceXML analysis executing means, and the result of the conversion is returned to the VoiceXML analysis executing means. In this case, a data file for a voice synthesis which is required for the conversion into voice data is acquired from the voice dialog data providing device 6.

Moreover, the voice information providing device 3 has such a structure that the voice signal output from the voice terminal 2 can be input. More specifically, the voice information providing device 3 has such a structure that an identifier (a Caller ID, a code number) for identifying the voice terminal 2 output from the dialog control device 7 and the VoiceXML document data can be input, and furthermore, electronic information such as a voice recognition grammar file, a file for a voice guidance, a data file for a voice synthesis and the like which are output from the voice dialog data providing device 6 can be input.

Furthermore, the voice information providing device 3 has such a structure that a voice signal can be output and the voice signal can be supplied to the voice terminal 2 through the public circuit switched network 1 as described above.

In addition, the voice information providing device 3 has such a structure that the URI of the VoiceXML document, the code number (Caller ID), the voice recognition result (Rec Result), the URI of the voice recognition grammar file, the URI of the file for a voice guidance and the request of the data file for a voice synthesis can be output. Moreover, the voice recognition result (Rec Result) is constituted to have a recognition vocabulary, the attribute of the recognition vocabulary, a plurality of recognition result candidates (N-best) corresponding to the certainty factor of a recognition, a recognition error (nomatch) in the case in which the certainty factor is equal to or less than a set value, and a recognition error (noinput) in the case in which an input volume is equal to or less than a set value.

The URI of the VoiceXML document, the code number (Caller ID) and the voice recognition result (Rec Result) in the signals output from the voice information providing device 3 is transmitted to the dialog control device 7 through the network 4.

On the other hand, the requests for the URI of the voice recognition grammar file, the URI of the file for a voice guidance and the data file for a voice synthesis in the signals output from the voice information providing device 3 are supplied to the voice dialog data providing device 6 through the network 4.

The voice dialog data providing device 6 is constituted to have an auxiliary recording medium (not shown) which can store data therein. The auxiliary recording medium of the voice dialog data providing device 6 stores the voice recognition grammar file, the file for a voice guidance and the data file for a voice synthesis.

Moreover, the voice dialog data providing device 6 has such a structure that these files can be supplied to the voice information providing device 3 through the network 4 in response to the request given from the voice information providing device 3. The voice dialog data providing device 6 can also be constituted by the same computer or different computers from each other. In addition, the voice dialog data providing device 6 can be included in the voice information providing device 3 and can be constituted by the same computer.

Furthermore, the dialog control device 7 serves to carry out synchronous control between the voice information providing device 3 and the screen information providing device 3, and the screen information providing device 8 is constituted to have at least a Web server, an application and a database. Respective means, for example, the Web server, the application, the database and the like in the screen information providing device 8 can be provided in the same computer and can also be provided in different computers from each other. The details of the dialog control device 7 and the screen information providing device 8 will be described below.

The voice information providing device 3, the dialog control device 7 and the screen information providing device 8 are mutually synchronized by using the document data for a dialog control. The document data for a dialog control can be used in the following manner, for example.

More specifically, first of all, in the case in which the user connects the screen terminal 5 to the dialog system according to the first embodiment through the public circuit switched network 1 and the network 4, a connection is subsequently established between the dialog system and the voice terminal 2.

In other words, in the casein which the user starts to connect the screen terminal 5 to the dialog system according to the first embodiment prior to the connection from the voice terminal 2, the document data for a dialog control to initialize the voice information providing device 3 are first transmitted from the screen information providing device 8 to the dialog control device 7.

In the dialog control device 7 receiving the document data for a dialog control, a voice dialog document generating section 24 (not shown) for generating document data for a voice dialog generates VoiceXML document data from the document data for a voice dialog. The VoiceXML document data thus generated are registered on a specific URI. The URI to be a registration destination is described in the document data for a dialog control.

In the voice information providing device 3, moreover, a request for the VoiceXML document data of the URI are set to be given when there is a connection from the voice terminal 2, and a request for corresponding VoiceXML document data is given when the connection is carried out.

On the other hand, in the case in which the user carries out a connection from the voice terminal 2 to the dialog system according to the first embodiment, the connection between the dialog system and the screen terminal 5 is established in the following manner.

In other words, it is assumed that VoiceXML document data for an initial connection (VoiceXML document data for an initial connection) are prepared before the user carries out the connection from the voice terminal 2. The VoiceXML document data for an initial connection are stored in the voice information providing device 3, the dialog control device 7 or a different device therefrom. Moreover, it is also possible to prepare the VoiceXML document data for an initial connection corresponding to an originator number or a terminating number.

When there is the connection from the voice terminal 2, the voice information providing device 3 executes the analysis of the VoiceXML document data for an initial connection. The voice recognition result (Rec Result) output by executing the analysis of the VoiceXML document data for an initial connection is transmitted from the voice information providing device 3 to the dialog control device 7.

Moreover, a request for the URI of the VoiceXML document to be next processed is given to the dialog control device 7. The dialog control device 7 receives a voice recognition result (Rec Result) and processes the same result based on the contents of a document for dialog control, and transmits the result of the processing to the screen information providing device 8. Moreover, the dialog control device 7 transmits VoiceXML document data corresponding to the required URI to the voice information providing device 3.

In the case in which the user carries out an input from the screen terminal 5 to the dialog system, furthermore, the synchronization of a voice dialog is carried out in the following manner.

More specifically, it is assumed that the dialog system is set in such a state that inputs from both the screen terminal 5 and the voice terminal 2 can also be accepted. In this state, if the input is given from the screen terminal 5, the document data for dialog control is transmitted from the screen information providing device 8 to the dialog control device 7. In the dialog control device 7, a VoiceXML document is generated from the document data for dialog control by the voice dialog document generating section 24 and a breaking instruction signal is transmitted to the voice information providing device 3.

Upon receipt of the breaking instruction signal, the voice information providing device 3 stops the Voice XML analysis execution, the voice recognition and the voice output. Correspondingly, the voice information providing device 3 gives a request for the URI of a new VoiceXML document to the dialog control device 7. The dialog control device 7 receiving the request transmits the generated VoiceXML document data for the request.

In the case in which the user carries out an input from the voice terminal 2 to the dialog system, moreover, a screen display is changed in the following manner.

More specifically, the dialog system is brought into such a state that both of inputs from the screen terminal 5 and the voice terminal 2 can be accepted. In the case in which the input of voice information is given from the voice terminal 2 to the voice information providing device 3 in this state, the voice recognition result (Rec Result) is transmitted from the voice information providing device 3 to the dialog control device 7.

In the dialog control device 7, the voice recognition result (Rec Result) is processed based on the document data for dialog control, and the result of the processing is transmitted to the screen information providing device 8.

In the screen information providing device 8, a processing of switching the contents displayed on the screen according to the result of the processing which is received.

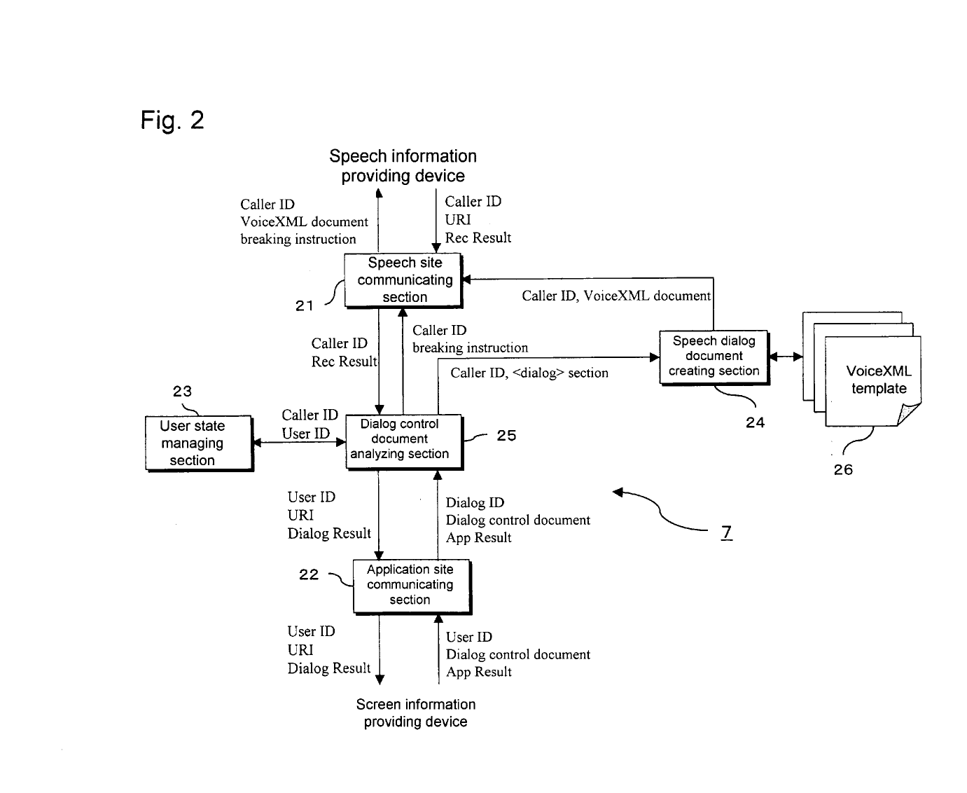

The dialog control device 7 will be described. FIG. 2 shows each section of the dialog control device 7 according to the first embodiment.

As shown in FIG. 2, the dialog control system 7 according to the first embodiment comprises a voice site communicating section 21, an application site communicating section 22, a user state managing section 23, a voice dialog document generating section 24 and a dialog control document analyzing section 25.

The voice site communicating section 21 has such a structure that the URI of the VoiceXML, a code number (Caller ID) and VoiceXML document data can be input. Moreover, the voice site communicating section 21 has such a structure that a signal for a code number (Caller ID) output from the dialog control document analyzing section 25 and a breaking instruction signal for a voice processing can be input and the code number (Caller ID) and the voice recognition result (Rec Result) can be output and supplied to the dialog control document analyzing section

The voice site communicating section 21 thus constituted carries out a session management by the cookie (Cookie) together with the voice information providing device 3. The cookie (Cookie) includes the code number (Caller ID) and the voice information providing device 3 and the dialog control device 7 can mutually correspond to the user of the voice terminal 2 by the cookie (Cookie).

Moreover, when the voice side communicating section 21 receives the URI of the VoiceXML document together with the code number (Caller ID) from the voice information providing device 3 and the contents thus received do not include the cookie (Cookie), a cookie (Cookie) is newly generated. Then, the voice site communicating section 21 transmits the VoiceXML document data present in the required URI to the voice information providing device 3 together with the code number (Caller ID)

On the other hand, in the case in which the voice site communicating section 21 receives the code number (Caller ID) and the voice recognition result (Rec Result) from the voice information providing device 3, the code number (Caller ID) and the voice recognition result (Rec Result) are transmitted to the dialog control document analyzing section 25 by the voice side communicating section 21. In the case in which the code number (Caller ID) and the breaking instruction signal are supplied from the dialog control document analyzing section 25 to the voice site communicating section 21, the code number (Caller ID) and the breaking instruction signal thus supplied are transmitted to the voice information providing device 3.

Next, the application site communicating section 22 has such a structure that the dialog control document data, an identifier (User ID, user ID) for specifying the user of the screen terminal 5 and the processing result of the screen information providing device 8 can be input from the screen information providing device 8 and the user ID (User ID), the URI and parameter values (parameter values (Dialog Result)) acquired from a voice dialog can be input. The processing result (App Result) can include the result of the input from the screen terminal 5 by the user, the processing result (App Result) of the screen information providing device 8 and the result of database retrieval.

Moreover, the application site communicating section 22 has such a structure that the user ID (User ID), the URI and the parameter value (Dialog Result) can be supplied to the screen information providing device 8 through the network 4 and the dialog control document data, the user ID (User ID) and the processing result (App Result) can be supplied to the dialog control document analyzing section 25.

The application site communicating section 22 has such a structure as to receive two of the user ID (User ID), the dialog control document data and the processing result (App Result), document data and to transmit these information to the dialog control document analyzing section 25.

Moreover, the application site communicating section 22 has such a structure as to receive the user ID (User ID), the URI and the parameter value (Dialog Result) and to transmit these information to the screen information providing device 8.

The user state managing section 23 has such a structure that the code number (Caller ID) and the user ID (User ID) can be input from the dialog control document analyzing section 25 and the code number (Caller ID) and the user ID (User ID) can be supplied to the dialog control document analyzing section 25. More specifically, the user state managing section 23 and the dialog control document analyzing section 25 are mutually constituted to input and output the code number (Caller ID) and the user ID (User ID). The code number (Caller ID) and the user ID (User ID) are used as the identifier of the user to cause the user of the voice terminal 2 to correspond to that of the screen terminal 5.

The user state managing section 23 has such a structure as to manage the identifiers of the code number (Caller ID) and the user ID (User ID) by a table to be a set of records.

Moreover, retrieval setting the code number (Caller ID) or the user ID (User ID) to be a key is carried out by the dialog control document analyzing section 25. The user state managing section 23 supplies an identifier corresponding as a result of the retrieval to the dialog control document analyzing section 25.

The voice dialog document generating section 24 has such a structure that the code number (Caller ID) and a portion surrounded by a set of tags (<dialog> and </dialog>) of the dialog control document can be input from the dialog control document analyzing section 25 and the code number (Caller ID) and the VoiceXML document data can be supplied to the voice site communicating section 21.

When inputting the <dialog> portion, the voice dialog document generating section 24 first substitutes the contents of the <dialog> portion for a VoiceXML template to generate the VoiceXML document data. Moreover, the optional number of VoiceXML templates 26 are prepared corresponding to the configuration of a dialog. Then, the VoiceXML document generated in the voice dialog document generating section 24 is transmitted to the voice site communicating section 21 together with the code number (Caller ID).

An example of the VoiceXML template prepared in the voice dialog document generating section 24 will be specifically described below.

More specifically, the syntax of the VoiceXML temperature for outputting a voice guidance can be represented by:

<dialog template = “T001”>

<prompt>*voice guidance character string*</prompt>

</dialog>
or
<dialog template = “T001”>

<prompt expr = “*evaluation expression*”/>

<dialog>.

Moreover, the syntax of the VoiceXML template for outputting the voice guidance and carrying out a voice recognition according to an optionally specified grammar can be represented by:

<dialog template = “T003”>

<init>

<prompt>*initial voice guidance character

string*</prompt>

</init>
<onNomatch retry=“*true or false*”count=“*error recovery

time*”>

<prompt>*voice guidance character string to be

output in nomatch* </prompt>

</onNomatch>
<onNoinput retry=“*true or false*”count=“*error recovery

time*”>

<prompt>*voice guidance character string to be

output in noinput* </prompt>

</onNoinput>
<grammar URI=“*grammar file URI*”slot“*slot

identifier*”/>

<result namelist=“*recognition state storage

variable**recognition vocabulary storage variable*”/>
</dialog>.

Then, the portion surrounded by a mark “*” in the example of the syntax described above is substituted for the VoiceXML template to generate the VoiceXML document.

Next, the case in which the VoiceXML document is generated from the <dialog> portion of the dialog control document data will be described by taking an example. As an example, the following <dialog> portion will be supposed.

<dialog template=“T003”>

<int>

<prompt> Please say a boarding station </prompt>

</int>
<onNomatch retry=“true” count=“1”>

<prompt> Please say the boarding station again

</prompt>

</onNomatch>
<onNoinput retry=“true” count=“2”>

<prompt> It is inaudible. Please say the boarding

station, for example, “Tokyo”.

</prompt>
</onNoinput>
<grammar

URI=http://grammarServer/station.grammarslot“=station”/>

<result namelist=“recStatus departure”/>

</dialog>.

In the example of the syntax described above, the meaning of each tag in the <dialog> portion will be sequentially described below. More specifically, a value (T003) of attribute tempelate of <dialog> indicates the identifier of the template. Moreover, the voice dialog document generating section 24 retrieves a corresponding VoiceXML template from the value of template and substitutes the contents of the <dialog> portion for the template.

Moreover, a set of <prompt> and </prompt> is described in a portion surrounded by <init> and </init> in order to output the initial guidance of the <dialog> portion. Furthermore, the sentence of a voice guidance is described in a portion surrounded by <prompt> and </prompt>. Herein, a voice guidance of “Please say a boarding station” is output.

Furthermore, a voice file put in the server on the network 4, for example, a Wav file or an MP3 file can also be used in the portion surrounded by <prompt> and </prompt>. In this case, a description of <audio src=http://audioServer/audioFileName.wav/> is given between <prompt> and </prompt>, for example.

In addition, a processing for acquiring nomatch as the voice recognition result (Rec Result) is described in <onNomatch>. In the case in which the value of the attribute retry is true, the sentence surrounded by <prompt> and </prompt> is output as a voice guidance.

Moreover, count is an attribute for the number of times that nomatch is acquired and a designated voice guidance is output until the number of times of nomatch reaches the value of count. The number of times of nomatch is managed for each code number (Caller ID).

Furthermore, a processing for acquiring noinput is described as the voice recognition result (Rec Result) in <onNoinput>. The processings of the attributes retry, count and <prompt> are the same as those of <onNomatch>.

In addition, the URI of the voice recognition grammar is specified for the <grammar>. Moreover, the voice recognition result is substituted for <result>.

Moreover, whether the recognition is successful is substituted for recStatus. If the recognition is successful, “ok” is input. If the recognition results in failure and an error is made, nomatch or noinput is input. A vocabulary recognized when recStatus is “ok” is input to departure. Herein, the name of the boarding station is input.

Based on the <dialog> portion described above, the following VoiceXML document is generated.

<?XML version=“1.0” encoding=“ISO-8859-1”?>
<!DOCTYPE vXML PUBLIC′-//DTD VoiceXML
1.0b//EN′′http://dtd/????/vXML.dtd′>
<vXML version=“1.0”>
<var name-“nomatch_count” expr=“1”/>
<var name-“noinput_count” expr=“1”/>
<form>

<field name=“station”>
<prompt> Please say a boarding station </prompt>
<grammar

src=http://grammarServer/station.grammar#station>

<catch even=“nomatch”>

<if cond=“nomatch_count==1”>

<prompt>Please say the boarding station again

</prompt>

<else if cond=“nomatch_count==”>

<goto

next=http://vXMLServer/departureErr.vXML”/>

</if>
<assign name=“nomatch_count”expr=“nomatch_count + 1”/>

</catch>
<catch event=“noinput”>

<if cond=“noinput_count==1”>

<prompt> It is inaudible. </prompt>
<prompt> Please say the boarding station, for

example, “Tokyo” </prompt>

<else if cond=“noinput_count==2”>

<prompt> It is inaudible. </prompt>
<prompt> Please say the boarding station, for

example, “Tokyo” </prompt>

<else if cond=“noinput_count==3”>

<goto next=http://vXMLServer/departureErr.vxML/>

</if>
<assign name=“noinput_count”expr=“noinput_count + 1”/>
</catch>
<filled>

<submit next=http://vXMLServer/departureConf.vML

namelist=“station”/>

</filled>

</form>

Moreover, the dialog control document analyzing section 25 has such a structure that the code number (Caller ID) and the voice recognition result (Rec Result) can be input from the voice site communicating section 21, dialog control document data, a user ID (User ID) and a processing result (App Result) can be input from the application site communicating section 22, and the code number (Caller ID) and the user ID (User ID) can be input from the user state managing section 23.

Furthermore, the dialog control document analyzing section 25 has such a structure that a code number (Caller ID) and a breaking instruction signal for a voice processing can be supplied to the voice site communicating section 21, a user ID (User ID), a URI and a parameter value (Dialog Result) can be supplied to the application site communicating section 22, a code number (Caller ID) and a user ID (User ID) can be supplied to the user state managing section 23, and a code number (Caller ID) and a portion (<dialog> portion) surrounded by <dialog> and </dialog> of the document for dialog control can be supplied to the voice dialog document generating section 24.

Description will be given to a processing to be carried out when the dialog control document data and the user ID (User ID) are supplied from the application site communicating section 22 to the dialog control document analyzing section 25.

More specifically, the dialog control document analyzing section 25 first carries out a retrieval based on the user ID (User ID) for the user state managing section 23, thereby acquiring a corresponding code number (Caller ID). At this time, in the case in which the user ID (User ID) to be retrieved is not present in the user state managing section 23, it is decided that a novel connection from the screen terminal 5 is carried out.

Description will be given on the assumption that there are three samples of the correspondence of the user ID (User ID) and the code number (Caller ID) in case of the novel connection.

First of all, description will be given to a first method in the case in which a novel connection to the dialog system according to the first embodiment is carried out. The first method is used in the case in which the user connects the screen terminal 5 to the dialog system prior to the voice terminal 2.

More specifically, the user first inputs a user identifier from the screen terminal 5. For the user identifier, for example, it is possible to use a telephone number, a digit sequence, a character string or a symbol string which is optionally created by the user or their mixture, or a digit sequence, a character string or a symbol string which is specified on the manage side of a dialog system or their mixture. It is preferable to use the user identifier which does not overlap with an identifier of another user.

Moreover, the user inputs the same user identifier by means of the voice terminal 2. In this case, it is also possible to eliminate a labor of the input of the user by setting the user identifier to be the telephone number of an originator.

The user identifier is input as the voice recognition result (Rec Result) from the voice information providing device 3 through the input of the user identifier by the user, while it is input as the document data for dialog control of the processing result (App Result) from the screen information providing device 8. Consequently, it is possible to cause the code number (Caller ID) owned by the same user identifier to correspond to the user ID (User ID).

Next, description will be given to a second method to be used in the case in which a novel connection to the dialog system according to the first embodiment is carried out.

More specifically, in the second method, when the user first carries out a connection to the dialog system from the voice terminal 2, the dialog system automatically generates an optional code number (a code number (Caller ID)) and informs the user of the code number through the voice terminal 2.

Next, the user carries out a connection to the dialog system from the screen terminal 5 and then inputs the code number acquired through the voice terminal 2 as the user ID (User ID) from the screen terminal 5. Since a subsequent method is the same as the first method, description will be omitted. In the second method, the same processing can also be carried out also in the case in which the screen terminal 5 is first connected and the voice terminal 2 is then connected.

The code number provided in the second method is given to the user by the dialog system. Moreover, only the user can know the code number. Therefore, it is possible to prevent a user having no privilege from being disguised as another person having the privilege differently from the case of a telephone number as in the first method. Accordingly, it is possible to enhance a security.

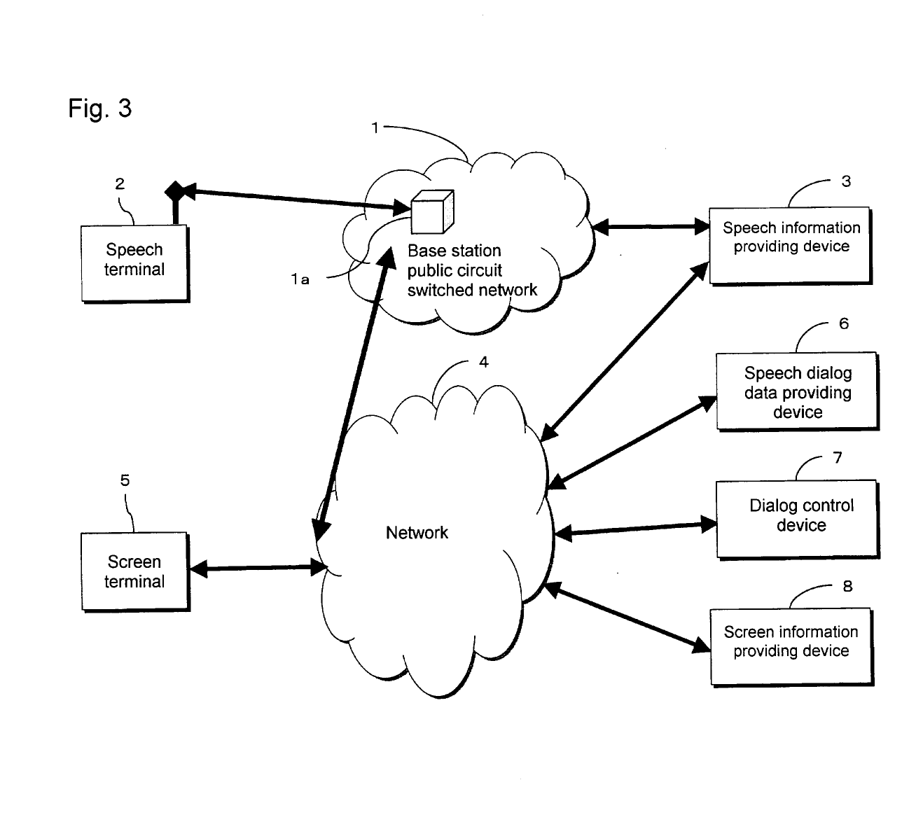

Next, description will be given to a third method to be carried out in the case in which a novel connection to the dialog system according to the first embodiment is carried out. FIG. 3 schematically shows correspondence of the voice terminal 2 to the screen terminal 5 in the novel connection according to the third method.

As shown in FIG. 3, in the third method, the correspondence of the voice terminal 2 to the screen terminal can be carried out by utilizing a principle in which the position of a user can be specified based on information about a base station executing a communication in a cell phone or the like.

More specifically, in the third method, when user first carries out a connection to the dialog system by using the voice terminal 2, the dialog system retrieves a base station la in which the voice terminal 2 performs a communication.

Then, when the user carries out the connection to the dialog system from the screen terminal 5, one voice terminal 2 is connected to the same base station la at a certain time. Furthermore, only when the voice terminal 2 and the screen terminal 5 are thus connected to the dialog system at the same time, it is possible to cause the voice terminal 2 to correspond to the screen terminal 5 directly and uniquely.

In this state, information is present on only the dialog system side. Therefore, it is possible to omit a labor for inputting information as in the first and second methods, thereby carrying out the correspondence of the voice terminal 2 to the screen terminal 5 more easily. In this case, it is also possible to carry out the same correspondence by utilizing a global positioning system (GPS).

Next, the document data for dialog control will be described. The document data for dialog control according to the first embodiment is an XML document, and the dialog control document analyzing section 25 analyzes and executes the contents of the XML document by using an XML purser.

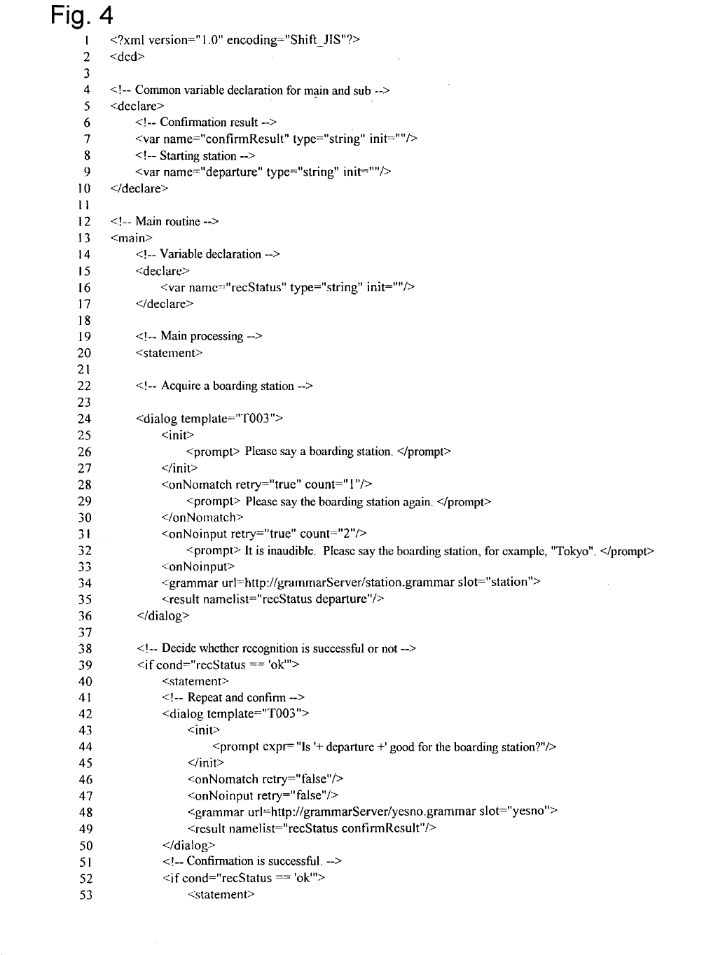

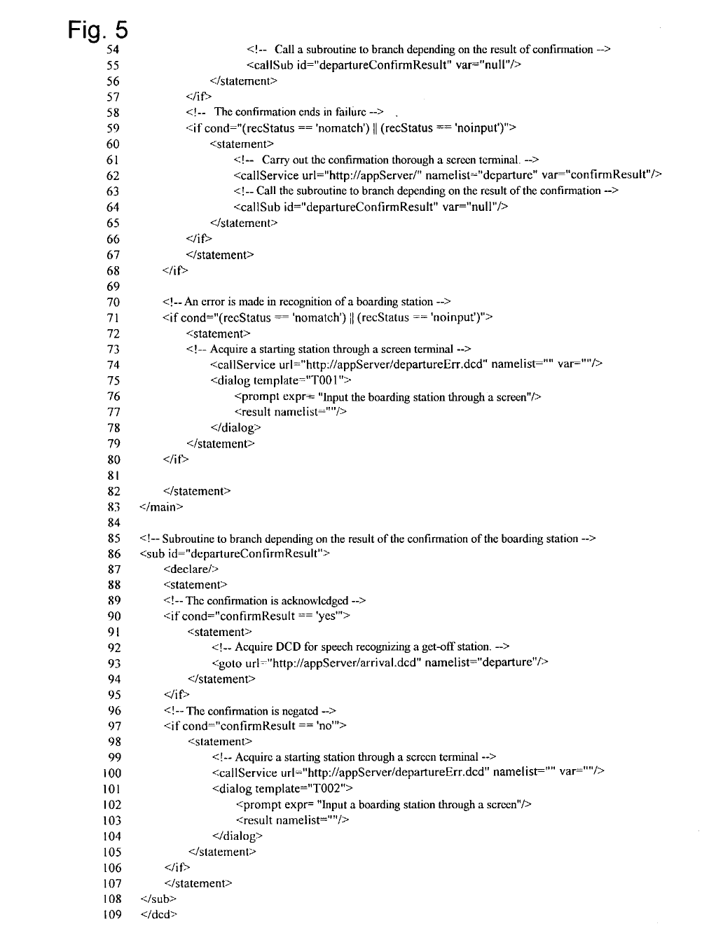

FIGS. 4 and 5 show an example of the document data for dialog control to be used when the processing is carried out by the dialog control document analyzing section 25. In FIGS. 4 and 5, a numeral on the left side indicates a line number.

By using the document data for dialog control shown in FIGS. 4 and 5, description will be given to the processing to be executed in the dialog control document analyzing section 25. The document data for dialog control shown in FIGS. 4 and 5 are a document for dialog control to acquire the boarding station of a train from the user. The document for dialog control can be used for the reservation and purchase of a train ticket, a timetable retrieval, a path retrieval or the like, for example. Moreover, a portion surrounded by a character string “<!. . . ” and a character string “. . . >” indicates a comment.

First of all, a first line of the document data for dialog control is a document based on an XML version 1.0 and is described in ISO-8859-1. Moreover, the “document for dialog control” in a second line is a tag indicative of the document for dialog control.

The document for dialog control is constituted by one main routine and an optional number of subroutines.

More specifically, 4th to 10th lines declare a variable to be used in common in the main routine and a subroutine. <declare> is a tag indicative of a variable declaration. “name” is an attribute indicative of a variable name, “type” is an attribute indicative of a variable type, and “init” is an attribute indicative of the initial value of a variable.

Moreover, 12th to 84th lines indicate a main routine and 86th to 108th lines indicate a subroutine. The range of the main routine is indicated by using a <main> tag and that of the subroutine is indicated by using a <sub> tag.

A processing for acquiring a boarding station is carried out from 22nd to 36th lines in the main routine. More specifically, the <dialog> tag in the 24th line indicates that Template ID uses a T003 VoiceXML template. A variable to be substituted for the VoiceXML template is described in the <dialog> portion.

When recognizing that the <dialog> portion is present in the document for dialog control, the dialog control document analyzing section 25 supplies information data in this portion to the voice dialog document generating section 24. In the voice dialog document generating section 24 to which the information data are input, the contents of the <dialog> portion are analyzed and the result of analysis is substituted for the designated VoiceXML template.

As shown in FIG. 2, next, the dialog control document analyzing section 25 supplies the code number (Caller ID) and the <dialog> portion to the voice dialog document generating section 24 and then supplies the code number (Caller ID) and the user ID (User ID) to the user state managing section 23.

Thus, the dialog control document analyzing section 25 is brought into such a standby state as to wait for information sent from the voice site communicating section 21 or the application site communicating section 22. In the standby state, in the case in which novel document data for dialog control are acquired from the application site communicating section 22, the analysis of the document data for dialog control is started and a breaking instruction signal is sent to the voice site communicating section 21. The contents of the <dialog> portion in this processing will be described in the following explanation of the voice dialog document generating section 24.

Moreover, a processing is carried out when a voice recognition is successful from 39th to 68th lines in the document data for dialog control shown in FIGS. 4 and 5.

More specifically, an evaluation expression is described in a value of cond in the <if> tag. If the value of the evaluation expression is true, a portion surrounded by <if> and </if> is executed. In the case in which recStatus is ok, the contents of the voice recognition (for example, the boarding station) are repetitively confirmed.

In addition, the evaluation expression is described in a value of expr in <prompt> on the 44th line. In the case in which four rules of arithmetic such as ‘+’ and a logical operator are present in the evaluation expression, an operation in accordance with the same operator is carried out. More specifically, in the case in which “Kyoto” is substituted for departure to be the voice recognition result, the result of the operation is “Is Kyoto good for the boarding station ?”.

Furthermore, the voice recognition result of the repetitive confirmation is substituted for <result> on the 49th line. Moreover, if the recognition is successful, “ok” is input to recStatus. If a recognition error is made, “nomatch” or “noinput” is input. If the user acknowledges the confirmation, “yes” is input to confirmResult. If the user denies the confirmation, “no” is input to confirmResult.

If the confirmation is successful, that is, recStatus is “ok”, departureconfirmResult of the subroutine is called as shown in the 55th line in FIG. 4. On the other hand, if the confirmation results in failure, that is, recStatus is “nomatch” or “noinput”, the confirmation is carried out in the screen terminal 5 by using <callservice> in the 62nd line.

Moreover, <callservice> is a tag for causing the server on the network to carry out a processing. The application of the server is designated by using the URI. Furthermore, a value of namelist is a parameter value (a parameter value (Dialog Result)) to be transferred to the server, and a value of var is a variable for storing the processing result of the server (processing result (App Result)) as a return value.

In the server, a corresponding application is executed based on the URI and the parameter value (Dialog Result) and the return value is returned to the dialog control device 7.

Moreover, the dialog control document analyzing section 25 executes <callService>, a so-called standby state in which the receipt of the return value is waited is brought. By using <callService>, thus, it is possible to switch and utilize a voice dialog and a screen display.

From the 71st line to the 80th line, furthermore, there is described a processing for acquiring the boarding station from the screen terminal 5 when an error is made in the recognition of the boarding state.

The utilization configuration of <callService> on the 74th line is different from <callService> on the 62nd line. More specifically, <callservice> is used for carrying out the voice dialog and the screen display at the same time.

If setting is carried out in the server to respond to the dialog control device 7 immediately when departureErr is received as namelist in the server, moreover, the selection screen of the boarding station is simultaneously displayed on the screen terminal 5.

In the dialog control document analyzing section 25, furthermore, a response is immediately given from the server through the application site communicating section 22. Therefore, the processing of “Please input the boarding station from the screen” to be a voice guidance on the 76th line can be executed. In the dialog control document analyzing section 25, thus, it is possible to simultaneously use the voice dialog and the screen display by utilizing <callService>.

From the 86th line to the 108th line, moreover, there is described a subroutine for branching based on the result of confirmation of the boarding station by the dialog control document analyzing section 25.

More specifically, if the confirmation is acknowledged, that is, confirmResult is “yes” as shown in the 90th line, the document data for dialog control for voice recognizing the boarding station are acquired.

In order to acquire novel document data for dialog control, moreover, <goto> is used as shown in the 93rd line. More specifically, the dialog control document analyzing section 25 gives a request for the URI represented by <goto> to the server and corresponding document data for dialog control are returned from the server. By using <goto>, thus, it is possible to change a dialog.

Next, description will be given to a processing to be carried out when a processing result (App Result) is input from the application site communicating section 22 to the dialog control document analyzing section 25.

More specifically, the processing result (App Result) is supplied as the return value of <callService> to the dialog control document analyzing section 25 together with the user ID (User ID). In the dialog control document analyzing section 25, moreover, analysis is carried out from the processing to be performed immediately after <callservice> of the corresponding document data for dialog control.

Description will be given to a processing to be carried out when a code number (Caller ID) and a voice recognition result (Rec Result) are input from the voice site communicating section 21 as shown in FIG. 2.

More specifically, when inputting the code number (Caller ID), the dialog control document analyzing section 25 retrieves the user state managing section 23 based on the code number (Caller ID). In the case in which the code number (Caller ID) of a retrieval object is retrieved by the retrieval, it is decided to be an input from the voice terminal 2 during a connection.

In the document data for dialog control shown in FIG. 5, moreover, the voice recognition result <Rec Result> is substituted for <result> of the <dialog> portion and the dialog control document analyzing section 25 carries out a processing immediately after the <dialog> portion. In the case in which the code number (Caller ID) to be retrieved is not present in the user state managing section 23, it is decided to be a novel connection from the voice terminal 2. The correspondence of the user ID (User ID) to the code number (Caller ID) in the novel connection is the same as described above.

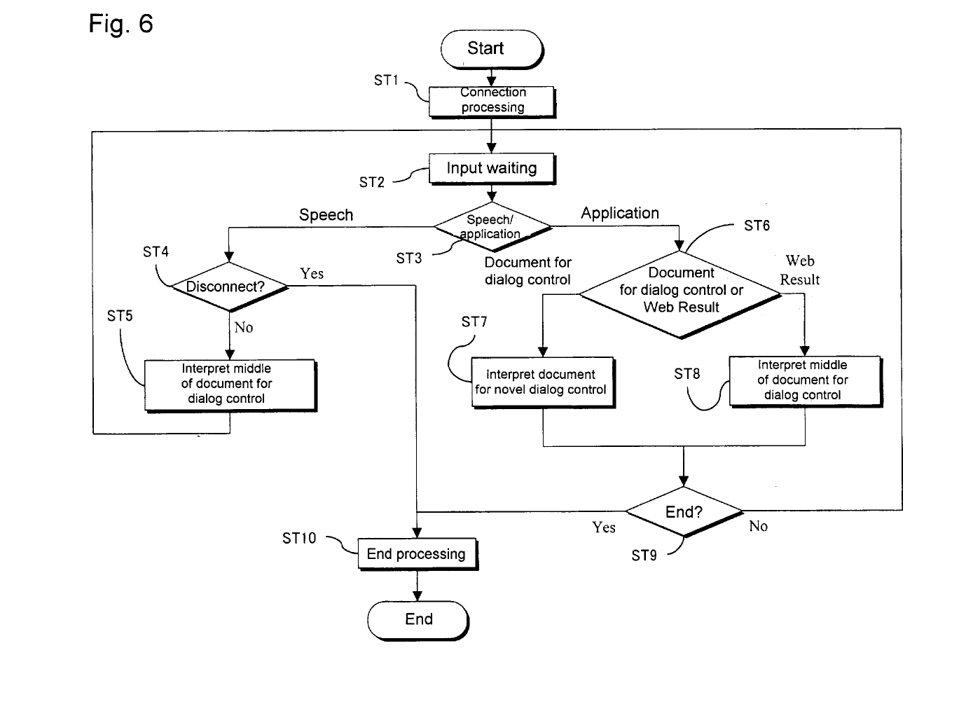

Next, description will be given to the processing procedure of the dialog control device 7 according to the first embodiment. FIG. 6 is a flowchart showing the processing procedure of the dialog control device 7.

More specifically, as shown in FIG. 6, a connection between the dialog control device 7 and the voice information providing device 3 or the screen information providing device 8 is started at a step ST1. In the case in which the dialog control device 7 and the voice information providing device 3 are connected to each other, the connection is started by giving a request for the URI of the VoiceXML document from the voice information providing device 3 to the voice side communicating section 21. The connection between the dialog control device 7 and the screen information providing device 8 is started by transmitting a document for dialog control from the screen information providing device 8 to the application site communicating section 22. Then, the processing proceeds to a step ST2.

At the step ST2, the dialog control device 7 is brought into such a standby state as to wait for an input from the voice information providing device 3 or the screen information providing device 8. At this time, in the case in which the <dialog> portion of the document for dialog control is being executed, a state in which an input from both servers is waited is brought. The input of the voice recognition result (Rec Result) from the voice information providing device 3 is waited and the input of the document data for dialog control or the processing result (App Result) from the screen information providing device 8 is waited. Thereafter, the processing proceeds to a step ST3.

At the step ST3, a subsequent processing branches depending on a device to be an input source. More specifically, if an input to the dialog control document analyzing section 25 is output from the voice information providing device 3, the processing proceeds to a step ST4. If the same input is output from the screen information providing device 8, the processing proceeds to a step ST6.

At the step ST4, the input supplied from the voice information providing device 3 is caused to branch depending on whether the voice terminal 2 is disconnected or not. If the input is not the disconnection, the processing proceeds to a step S5. On the other hand, if the input is the disconnection, the processing proceeds to a step ST10.

In the step ST5, the input supplied from the voice information providing device 3 is not the disconnection but the voice recognition result (RecResult) is substituted for<result> of the <dialog> portion. Therefore, the processing of the document data for dialog control is executed immediately after the <dialog> portion. Then, the processing proceeds to the step ST2 in which the standby state is brought.

On the other hand, if the input supplied from the voice information providing device 3 is the disconnection at the step ST4, the processing proceeds to a step ST10 in which an end processing is carried out and a corresponding record in the user state managing section 23 is deleted.

At the step ST3, moreover, if the input is the output of the screen information providing device 8, the processing proceeds to the step ST6. At the step ST6, branching is carried out depending on whether the input of the screen information providing device 8 is the document data for dialog control or the processing result (App Result). More specifically, if the input of the screen information providing device 8 is document data for dialog control, the processing proceeds to a step ST7. If the same input is the processing result (App Result), the processing proceeds to a step ST8.

If the input of the screen information providing device 8 is the document data for dialog control, the processing proceeds to the step ST7. If the acquirement of a novel document for dialog control is not based on <goto>, the dialog control document analyzing section 25 first sends a breaking instruction signal to the voice site communicating section 21. Then, the dialog control document analyzing section 25 analyzes and executes the novel document data for dialog control. Then, the processing proceeds to a step ST9.

On the other hand, if the input of the screen information providing device 8 is the processing result (App Result), the processing proceeds to the step ST8. At the step ST8, the processing result (App Result) is given as the return value of the <callservice> to the dialog control document analyzing section 25. Therefore, the dialog control document analyzing section 25 carries out a processing of the document for dialog control immediately after <callService>. Then, the processing proceeds to the step ST9.

At the step ST9, branching is carried out depending on whether a <exit/> tag indicative of an end is present in the document data for dialog control.

More specifically, if the <exit/> tag is not present in the document data for dialog control, there are the <dialog> portion, <goto> or <callservice> are present. Therefore, the processing proceeds to the step ST2 in order to stand by the input from the voice information providing device 3.

On the other hand, if the <exit/> tag is present in the document data for dialog control, the processing proceeds to the step ST10 in which the ending processing is carried out and the corresponding record of the user state managing section 23 is deleted.

As described above, the processing of the dialog control device 7 is carried out.

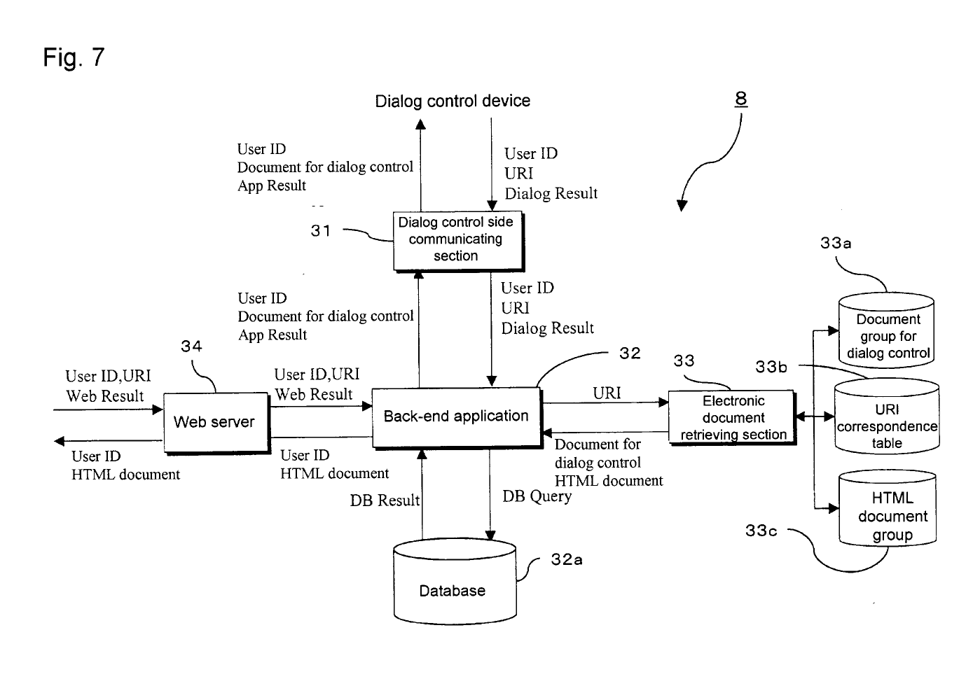

Next, the output is controlled by the dialog control device 7. Description will be given to the screen information providing device 8 according to the first embodiment. FIG. 7 shows the structure of the screen information providing device 8 according to the first embodiment.

As shown in FIG. 7, the screen information providing device 8 according to the first embodiment is constituted by a dialog control side communicating section 31, a back-end application 32 capable of retrieving a database 32a, an electronic document retrieving section 33 having a dialog control document group database 33a, a URI correspondence table database 33b and an HTML document group database 33c, and a Web server 34.

The dialog control side communicating section 31 has such a structure that a user ID (User ID), a URI and a parameter value (Dialog Result) can be input from the dialog control device 7 and a user ID (User ID), document data for dialog control and a processing result (App Result) can be input from the back-end application 32.

Moreover, the dialog control side communicating section 31 has such a structure that the user ID (User ID), the document data for dialog control and the processing result (App Result) can be output to the dialog control device 7 and the user ID (User ID), the URI and the parameter value (Dialog Result) can be output to the back-end application 32.

In the dialog control side communicating section 31 thus constituted, in the case in which the user ID (User ID) and the document for dialog control are supplied from the back-end application 32, these user ID (User ID) and the document for dialog control are transmitted to the dialog control device 7. On the other hand, in the case in which the dialog control side communicating section 31 acquires the user ID (User ID) and the processing result (App Result) from the back-end application 32, these user ID (User ID) and the processing result are transmitted to the dialog control device 7.

Moreover, in the case in which the dialog control side communicating section 31 receives the user ID (User ID), the URI and the parameter value (Dialog Result) from the dialog control device 7, these user ID (User ID), the URI and the parameter value (Dialog Result) are supplied to the back-end application 32.

The back-end application 32 has such a structure that the user ID (User ID), the URI and the parameter value (Dialog Result) can be input from the dialog control side communicating section 31 and the user ID (User ID), the URI of the HTML document and the operation result (Web Result) of the screen terminal 5 can be input from the Web server 34. Moreover, the back-end application 32 has such a structure that the database 32acan be retrieved, and a database retrieval result (a database retrieval result (DB Result)) is input from the database 32a. Moreover, the back-end application 32 has such a structure that the document data for dialog control and the HTML document can be input from the electronic document retrieving section 33.

Moreover, the back-end application 32 has such a structure that the user ID (User ID), the document data for dialog control and the processing result (App Result) can be supplied to the dialog control side communicating section 31 and the HTML document can be supplied to the Web server 34, for example. Furthermore, the back-end application 32 has such a structure that a database retrieval expression (DB Query) can be supplied to the database 32a. By utilizing the database retrieval expression (DB Query), the database 32acan be retrieved. In addition, the back-end application 32 has such a structure that the URI can be supplied to the electronic document retrieving section 33.

When receiving the user ID (User ID), the URI and the parameter value (Dialog Result), the back-end application 32 carries out a processing according to the contents thereof or a program.

More specifically, the back-end application 32 transmits the URI to the electronic document retrieving section 33 and the document data for dialog control or the HTML document data corresponding to the URI thus transmitted are acquired from the electronic document retrieving section 33. In addition, the back-end application 32 issues the database retrieval expression (DB Query) to the database 32aand acquires a database retrieval result (DB Result) to be a retrieval result from the database 32a.

On the other hand, in the case in which the document data for dialog control or the HTML document are/is acquired from the electronic document retrieving section 33, first of all, the database retrieval expression (DB Query) is issued to the database. Then, the database retrieval result (DB Result) is supplied as a result from the database.

Thereafter, the back-end application 32 transmits the document data for dialog control generated based on the acquired document data for dialog control or the acquired document data for dialog control together with the user ID (User ID) to the dialog control communicating section. The document data for dialog control can include information about the database retrieval result (DB Result) or a processing result thereof, the operation result (Web Result) of the screen terminal 5 or a processing result thereof, or a parameter value (Dialog Result) or a processing result thereof.

Moreover, the back-end application 32 transmits the acquired HTML document or an HTML document generated based on the acquired HTML document together with the user ID (User ID) to the Web server 34. The HTML document can include information about the database retrieval result (DB Result) or a processing result thereof, Web Result or a processing result thereof, or a parameter value (Dialog Result) or a processing result thereof.

When acquiring the database retrieval result (DB Result) from the database, furthermore, the back-end application 32 issues the database retrieval expression (DB Query) to the database 32acorresponding to the contents thereof or a program. Then, the back-end application 32 acquires the database retrieval result (DB Result) from the database 32a.

In addition, the back-end application 32 supplies the URI to the electronic document retrieving section 33 and document data for dialog control corresponding to the URI or HTML document data are acquired from the electronic document retrieving section 33.

Subsequently, the back-end application 32 can supply the processing result (App Result) together with the user ID (User ID) to the dialog control side communicating section 31. The processing result (App Result) can include information about the database retrieval result (DB Result) or a processing result thereof, Web Result or a processing result thereof, or a parameter value (Dialog Result) or a processing result thereof.

Then, in the case in which the back-end application 32 acquires the user ID (User ID), the URI and the operation result (Web Result) of the screen terminal 5 from the Web server 34, it carries out a processing corresponding to these contents or a program.

More specifically, first of all, the back-end application 32 transmits the URI to the electronic document retrieving section 33 and acquires document data for dialog control corresponding to the URI or HTML document data from the electronic document retrieving section 33. Then, the back-end application 32 issues a database retrieval expression (DB Query) to the database 32a and acquires a database retrieval result (DB Result) as a result from the database 32a.

The processing result (App Result) is transmitted together with the user ID (User ID) to the dialog control side communicating section 31. The processing result (App Result) can include information about the database retrieval result (DB Result) or a processing result thereof, the operation result (Web Result) of the screen terminal 5 or a processing result thereof, or a parameter value (Dialog Result) or a processing result thereof.

Moreover, the electronic document retrieving section 33 has such a structure that the URI can be input from the back-end application 32 and the document data for dialog control and the HTML document data can be output to the back-end application 32.

When acquiring the URI from the back-end application 32, first of all, the electronic document retrieving section 33 thus constituted retrieves the URI correspondence table database 33b. In the URI correspondence table database 33b, identifiers for the document data for dialog control for the acquired URI and the HTML document are recorded. The identifiers are retrieved by setting the URI to be a retrieval key.

Then, the electronic document retrieving section 33 acquires at least one of the document data for dialog control and the HTML document data based on the identifier thus retrieved. The electronic document retrieving section 33 transmits the document data for dialog control or the HTML document data thus acquired to the back-end application 32.

In addition, since the Web server 34 is the same as that of a conventional well-known Web server, description will be omitted.

As described above, the voice system according to the first embodiment is constituted and a user can utilize the voice recognition system by using the voice terminal 2 and the screen terminal 5.

As described above, according to the first embodiment, the recognition of a voice sent from the voice terminal 2 is executed by the voice information providing device 3 through the public circuit switched network 1 and the provision of information to the screen terminal 5 is executed by the screen information providing device 8 through the network 4, and the mutual control of the voice information providing device 3 and the screen information providing device 8 is carried out by the dialog control device 7. Consequently, the voice terminal 2 and the screen terminal 5 can only have the function of carrying out a connection to the public circuit switched network 1 and the network 4, thereby performing a communication. Thus, the voice recognition system and the display screen can be controlled. Even a terminal having only the performance of a cell phone can be used for a voice recognition, a contact input, a voice output and a screen display, and a dialog using them can be controlled.

Second Embodiment

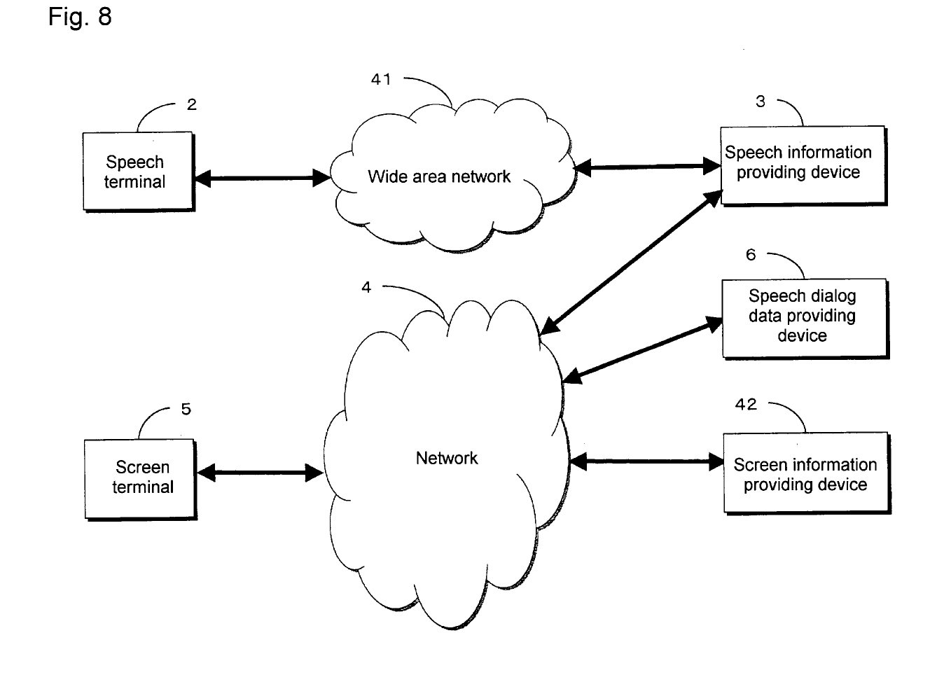

Next, description will be given to a dialog system according to a second embodiment of the present invention. FIG. 8 shows a state in which a voice terminal and a screen terminal are connected to the dialog system according to the second embodiment.

In the dialog system according to the second embodiment, a wide area network 41 including a public circuit switched network 1 and the like is utilized for the connection of a voice terminal 2 differently from the first embodiment.

In the dialog system according to the second embodiment, moreover, a dialog control device 7 is not provided and VoiceXML document data can be directly provided from a screen information providing device 42 to a voice information providing device 3 differently from the first embodiment.

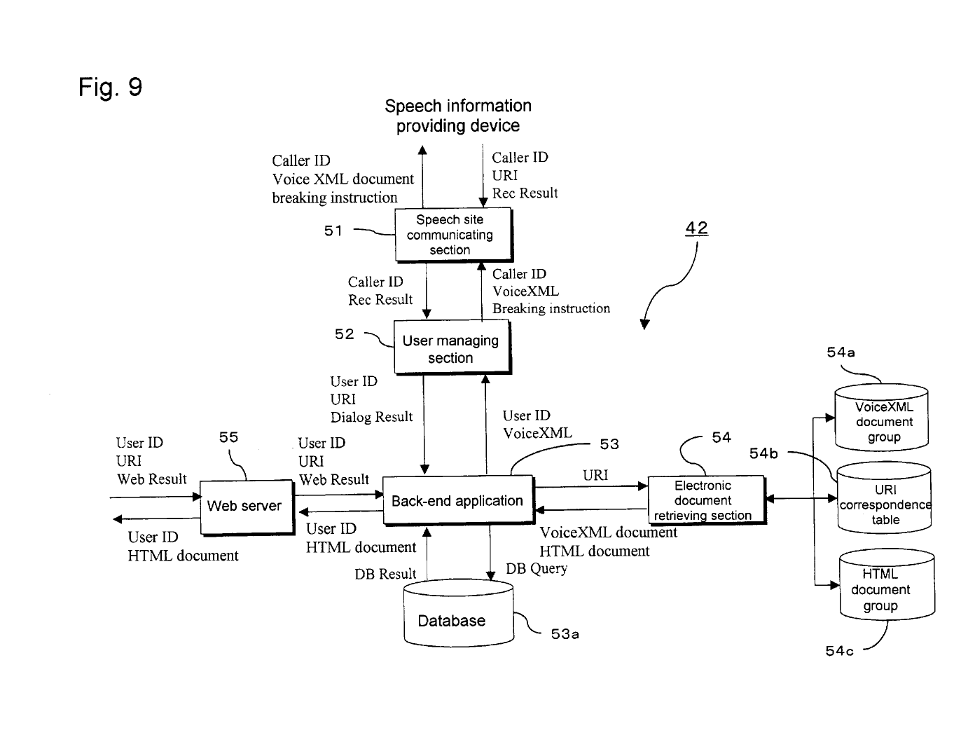

Since other structures are the same as those in the first embodiment, only the screen information providing device 42 will be described in the second embodiment. FIG. 9 shows the structure of the screen information providing device 42 according to the second embodiment.

As shown in FIG. 9, the screen information providing device 42 according to the second embodiment is constituted by a voice site communicating section 51, a user managing section 52, a back-end application 53 capable of retrieving a database 53a, an electronic document retrieving section 54 capable of retrieving a dialog control document group database 54a, a URI correspondence table database 54b and an HTML document group database 54c, and a Web server 55.

The voice site communicating section 51 has such a structure that a URI of the VoiceXML document, a code number (Caller ID) and a voice recognition result (Rec Result) can be input from the voice information providing device 3 and a code number (Caller ID), VoiceXML document data and a breaking instruction signal of a voice processing can be input from a user managing section 52.

Moreover, the voice site communicating section 51 has such a structure that a code number (Caller ID), a VoiceXML document and a breaking instruction signal of a voice processing can be transmitted to the voice information providing device 3 and a code number (Caller ID) and a voice recognition result (Rec Result) can be supplied to the user managing section 52.

Furthermore, the voice site communicating section 51 carries out a session management by a cookie (Cookie) together with the voice information providing device 3. In addition, the cookie (Cookie) can include the code number (Caller ID) so that the user of the voice terminal 2 can be caused to mutually correspond to the voice information providing device 3 and the screen information providing device 42.

The voice site communicating section 51 thus constituted receives the code number (Caller ID) and the URI of the VoiceXML document from the voice information providing device 3. In the case in which the cookie (Cookie) is not included in the contents received from the voice information providing device 3, the cookie (Cookie) is newly generated. Moreover, the voice site communicating section 51 transmits the VoiceXML document present in the required URI together with the code number (Caller ID) to the voice information providing device 3.

On the other hand, in the case in which the voice site communicating section 51 receives the code number (Caller ID9 and the voice recognition result (Rec Result) from the voice information providing device 3, it transmits the code number (Caller ID) and the voice recognition result (Rec Result) to the user managing section 52. Moreover, in the case in which a code number (Caller ID) and a breaking instruction signal are input from the user managing section 52 to the voice site communicating section 51, the voice site communicating section 51 transmits the code number (Caller ID) and the breaking instruction signal to the voice information providing device 3.

Furthermore, the user managing section 52 has such a structure that a code number (Caller ID) and a voice recognition result (Rec Result) can be input from the voice site communicating section 51 and the user ID (User ID) and the VoiceXML document data can be input from the back-end application 53.

In addition, the user managing section 52 has such a structure that a code number (Caller ID), VoiceXML document data and a breaking instruction signal can be supplied to the voice site communicating section 51 and a user ID (User ID), a URI and a parameter value (Dialog Result) can be supplied to the back-end application 53.

In the user managing section 52 thus constituted, the code number (Caller ID) and the user ID (User ID) are caused to correspond to each other and are managed by the same method as that in the user state managing section 23 (see FIG. 2) according to the first embodiment.

When receiving the code number (Caller ID) and the voice recognition result (Rec Result) from the voice site communicating section 51, the user managing section 52 converts the code number (Caller ID) into the user ID (User ID) and transmits them together with the parameter value (Dialog Result) to the back-end application 53. In the second embodiment, the voice recognition result (Rec Result) and the parameter value (Dialog Result) have the same values.

Moreover, in the case in which the user managing section 52 acquires the user ID (User ID) and the VoiceXML document data from the back-end application 53, different processings from each other are carried out in an input timing thereof.

More specifically, in the case in which the user managing section 52 transmits the VoiceXML document data to the voice site communicating section 51 and the user ID (User ID) and the VoiceXML document are supplied from the back-end application 53 before the voice recognition result (Rec Result) is acquired from the voice site communicating section 51, the user managing section 52 converts the user ID (User ID) into the code number (Caller ID) and transmits the code number (Caller ID), the breaking instruction signal and the VoiceXML document to the voice site communicating section 51.

On the other hand, in the case in which the user managing section 52 transmits the VoiceXML document data to the voice site communicating section 51, the voice recognition result (Rec Result) is then acquired from the voice site communicating section 51 and the user ID (User ID) and the VoiceXML document data are thereafter supplied from the back-end application 53, the user managing section 52 converts the user ID (User ID) into the code number (Caller ID) and transmits the code number (Caller ID) and the VoiceXML document data supplied from the back-end application 53 to the voice site communicating section 51.

The back-end application 53 and the electronic document retrieving section 54 are different from those of the first embodiment in that the VoiceXML document data are used in place of the document data for dialog control according to the first embodiment. Since other structures are the same as those of the first embodiment, description will be omitted. Moreover, an input, an output and a processing in the Web server 55 are the same as those of a conventional Web server.

According to the second embodiment, the same advantages as those of the first embodiment can be obtained. In addition, the screen information providing device 42 has the functions of both the dialog control device and the screen information providing device according to the first embodiment. Consequently, it is possible to more simplify the structure of the dialog system than that in the first embodiment.

Third Embodiment

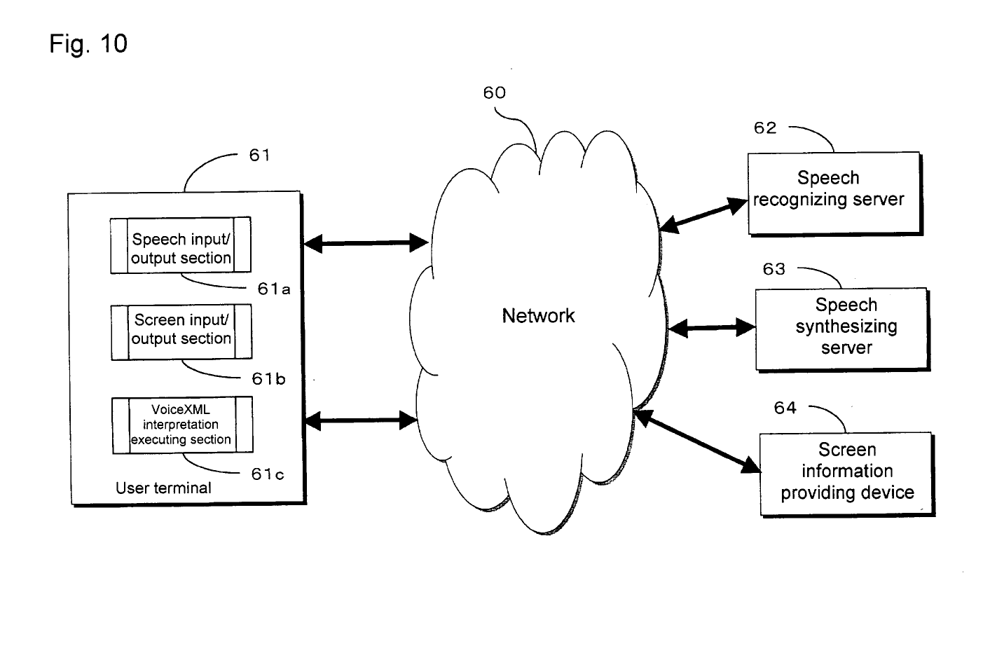

Next, description will be given to a dialog system according to a third embodiment of the present invention. FIG. 10 shows the dialog system according to the third embodiment.

As shown in FIG. 10, the dialog system according to the third embodiment is different from that in the first embodiment in that means for analyzing and executing VoiceXML document data (VoiceXML analysis executing means) is provided in a user terminal uniting the voice terminal 2 and the screen terminal 5.

More specifically, the dialog system according to the third embodiment is constituted by a user terminal 61, a voice recognizing server 62, a voice synthesizing server 63 and a screen information providing device 64 which are connected to a network 60.

The user terminal 61 is constituted to have at least a voice input/output section 61a, a screen input/output section 61b and a VoiceXML analysis executing section 61c.

The voice input/output section 61a has the sane function as that of the voice terminal 2 according to the first embodiment. Moreover, the screen input/output section 61b has the same function as that of the screen terminal 5 according to the first embodiment. Moreover, the Voice XML analysis executing section 61c has the same function as that of the VoiceXML analysis executing means according to the first embodiment.

The user terminal 61 having the structure has such a structure that a voice, DTMF, text information and pointing information can be directly input from a user. Moreover, the user terminal 61 has such a structure that a voice recognition result (Rec Result) can be received from the voice recognizing server 62 through the network 60, a voice signal can be received from the voice synthesizing server 63 and electronic information such as HTML document data and VoiceXML document data can be received from the screen information providing device 64.

Moreover, the user terminal 61 has such a structure that a voice and screen information can be output to the user in a recognizable state. Furthermore, the user terminal 61 has such a structure that a voice signal, a URI of a voice recognition grammar file and a vocabulary to be a voice recognition object can be transmitted to the voice recognizing server 62 through the network 60, a URI of a file for a voice guidance and a test for voice synthesis can be transmitted to the voice synthesizing server 63, and a URI of electronic information, an identifier (hereinafter referred to as a user ID (User ID)) for identifying a user terminal and a voice recognition result (Rec Result) can be transmitted to the screen information providing device 64.

In the user terminal constituted as described above, a session management is carried out by a cookie (Cookie) together with the screen information providing device 64. Thus, the cookie (Cookie) includes the user ID (User ID) so that the screen information providing device 64 can identify the user terminal 61.

In addition, when text information, pointing information, a URI and a voice recognition result are input by the user, these information data are transmitted to the screen information providing device 64. When the user terminal 61 receives electronic information about a screen display from the screen information providing device 64, information based on the electronic information is displayed on a predetermined screen.

Moreover, when the user terminal 61 receives the VoiceXML document data from the screen information providing device 64, the VoiceXML document data are analyzed and executed in the VoiceXML analysis executing section of the user terminal 61.

In the case in which a description for executing a voice recognition is present in the VoiceXML document data received by the user terminal 61, the user terminal 61 transmits a signal for requiring a recognition to the voice recognizing server 62 and a result of the recognition is acquired. The signal for requiring the recognition includes the URI of the voice recognition grammar file or information data on a vocabulary to be a recognition object.

Moreover, in the case in which a description for executing a voice synthesis is present in the VoiceXML document data received by the user terminal 61, the user terminal 61 transmits a signal for requiring the synthesis of a voice to the voice synthesizing server 63 and acquires the result of a synthesis. The signal for requiring the synthesis includes a text for a voice synthesis.

In addition, in the case in which a description for outputting a file for a voice guidance is present in the VoiceXML document data received by the user terminal 61, the user terminal 61 transmits a signal for requiring a voice guidance to the voice synthesizing server 63. The signal for requiring the voice guidance include information data on the URI of the file for a voice guidance.

Furthermore, in the case in which a description for acquiring the VoiceXML document data is present in the VoiceXML document data received by the user terminal 61, the signal for requiring the VoiceXML document data is transmitted to a storage address designated by the URI.

Next, the voice recognizing server 62 has such a structure that a voice signal, a URI of a voice recognition grammar file and a voice recognition object vocabulary can be received from the user terminal 61 through the network 60.

Moreover, the voice recognizing server 62 has such a structure that a voice recognition result (Rec Result) can be transmitted to the user terminal 61 through the network 60.

The voice recognizing server 62 carries out a voice recognition by analyzing the voice signal acquired from the user terminal 61. In the voice recognition, the URI of the voice recognition grammar file or the voice recognition object vocabulary which is acquired together with the voice signal is used. In the case in which the URI of the voice recognition grammar file is used, the voice recognition grammar file is acquired from a corresponding URI and is used for the voice recognition. The result of the voice recognition is returned as a voice recognition result (Rec Result) from the voice recognizing server 62 to the user terminal 61 through the network 60.

The voice synthesizing server 63 has such a structure that a URI of a file for a voice guidance and a test for a voice synthesis can be received from the user terminal 61 and a voice signal can be transmitted to the user terminal 61 through the network 60.

When receiving the test for a voice synthesis which is acquired from the user terminal 61, the voice synthesizing server 63 executes at least one of the following two processings and returns a voice signal to the user terminal 61. More specifically, the voice synthesizing server 63 converts the text for a voice synthesis acquired from the user terminal 61 into a voice signal and then returns the same voice signal to the user terminal 61 through the network 60 or retrieves a voice file based on the text for a voice synthesis, and converts the contents of the voice file thus retrieved into a voice signal and thereafter returns the same voice signal to the user terminal 61 through the network 60.

In the case in which the voice synthesizing server 63 receives the URI from the user terminal 61, moreover, the file for a voice guidance is retrieved based on the URI thus received and the contents of the file for a voice guidance thus retrieved is converted into a voice signal and is then returned to the user terminal 61 through the network 60.

The screen information providing device 64 is the same as the so-called screen information providing device 42 according to the second embodiment which has the screen information providing device 8 and the dialog control device 7 according to the first embodiment.

More specifically, the screen information providing device 64 has such a structure that a URI of electronic information, a user ID (User ID) and a voice recognition result (Rec Result) can be received from the user terminal 61 and the electronic information can be transmitted to the user terminal 61.

In the dialog system according to the third embodiment which is constituted as described above, the same advantages as those of the first embodiment can be obtained and the VoiceXML document data can be analyzed and executed in the user terminal 61. Consequently, the load of a voice recognition processing can be distributed and the speed of the processing of the dialog system can be increased.

While the embodiments of the present invention have been specifically described above, the present invention is not restricted to the above-mentioned embodiments but various modifications based on the technical thought of the present invention can be made.

For example, the document data for dialog control in the above-mentioned embodiments are only illustrative and different document data for dialog control can be used if necessary.

Furthermore, while the voice information providing device 3, the voice dialog data providing device 6, the dialog control device 7 and the screen information providing device 8 can be constituted by different computers from each other in the first embodiment, for example, at least two of the voice information providing device 3, the voice dialog data providing device 6, the dialog control device 7 and the screen information providing device 8 can also be constituted by the same computer.

Moreover, while the voice terminal 2 and the screen terminal 5 are constituted by different computers respectively in the first embodiment, for example, it is also possible to constitute the voice terminal 2 and the screen terminal 5 by the same terminal. In other words, it is also possible to constitute the voice terminal 2 and the screen terminal 5 by different terminals or the same terminal.

In addition, while the voice terminal 2 and the voice information providing device 3 are connected to be mutually commutable through the public circuit switched network 1 in the first embodiment, for example, it is also possible to connect them through a local area network (LAN) or a wide area network such as an internet. Furthermore, it is also possible to constitute the network by a voice over IP.

Moreover, while the back-end application 32 is supplied from the electronic document retrieving section 33 or the HTML document is used as document data to be supplied to the Web server 34 in the first embodiment, for example, the HTML document is only illustrative and data other than the HTML document can be used. For example, it is also possible to use document data utilizing another markup language and to use document data including a document generated by utilizing a common gateway interface, active server pages, Java (registered trademark) servelet, Java Server Pages and the like.

As described above, according to the present invention, information stored in a computer on a network can be retrieved by using both a voice and a screen, and at the same time, a voice recognition is carried out in a voice information providing device and a voice recognizing device. Consequently, a user can utilize a conventional device such as a cell phone without purchasing new software or hardware and can utilize a communicating terminal in a moving environment such as a portable telephone.

According to the present invention, moreover, the voice information providing device and the dialog control device can communicate with the screen information providing device. Therefore, the manager of the screen information providing device can provide information which can be operated by a voice dialog processing to a user having a first communicating terminal and a second communicating terminal or a composite communicating terminal without introducing a device for carrying out a voice recognition.

According to the present invention, furthermore, the dialog control device can generate information for a voice dialog based on electronic information acquired from the screen information providing device. Consequently, it is possible to provide information for operating a voice dialog processing without requiring an expertism for a server manager.

According to the fifth aspect of the present invention, moreover, it is possible to switch the input/output means depending on circumstances in the dialog control device. In the dialog system having the dialog control device, therefore, an efficient dialog communication can be carried out, for example, a proper noun is input, a voice recognition is utilized in case of a selection from a large number of choices, or a contact input is utilized in case of a small number of choices such as alternative.

What is claimed is:

1. A dialog system comprising:
a voice information providing device constituted to output voice information;
a screen information providing device constituted to output screen information; and
a dialog control device having constituted to transmit/receive electronic information to/from the screen information providing device and the voice information providing device,
a first communicating terminal which is commutable to at least the screen information providing device and a second communicating terminal commutable to at least the voice information providing device being constituted to be connectable,
the screen information providing device having a recording section for recording first electronic information to be transmitted to the first communicating terminal constituted to display visual information and second electronic information to be used in the dialog control device, and being constituted to execute at least one of a processing of transmitting the first electronic information to the fist communicating terminal and a processing of transmitting the second electronic information to the dialog control device based on information received from the first communicating terminal or the dialog control device,
the voice information providing device being constituted to transmit, to the second communicating terminal, voice information based on information for a voice dialog generated by the dialog control device and constituted to recognize the received voice information to generate a voice recognition result based on the information for a voice dialog, thereby transiting the same result of the dialog control device, and
the dialog control device being constituted to generate the information for a voice dialog and to transmit the same information to the voice information providing device based on the second electronic information upon receipt of the second electronic information and constituted to transmit information related to the voice recognition result to the screen information providing device based on the second electronic information upon receipt of the voice recognition result from the voice information providing device.

2. The dialog system according to claim 1, wherein the screen information providing device, the voice information providing device and the dialog control device are constituted to be mutually connectable through a network, and the first communicating terminal and the second communicating terminal are constituted to be connectable through the network.

3. A dialog system in which a screen information providing device and a voice information providing device are connected to each other,
the screen information providing device having a recording section capable of recording first electronic information to be transmitted to a first communicating terminal capable of displaying visual information and second electronic information to be used in the voice information providing device and being constituted to execute at least one of a processing of transmitting the first electronic information to the first communicating terminal based on information received from the first communicating terminal or the voice information providing device upon receipt of the same information and a processing of transmitting the second electronic information to the voice information providing device, and
the voice information providing device being constituted to transmit voice information based on the second electronic information to a second communicating terminal capable of outputting a voice upon receipt of the second electronic information from the screen information providing device and being constituted to recognize voice information the received voice information based on the second electronic information to generate a voice recognition result upon receipt of the voice information from the second communicating terminal and to transmit the voice recognition result to the screen information providing device.

4. The dialog system according to claim 1 or 3, wherein the first communicating terminal and the second communicating terminal are constituted by the same terminal.

5. The dialog system according to claim 3, wherein the screen information providing device and the voice information providing device are constituted to be mutually connectable through a network, and the first communicating terminal or the second communicating terminal is constituted to be connectable through the network.

6. A dialog system in which a screen information providing device, a dialog control device and a voice recognizing device are mutually connected and a communicating terminal is constituted to be connectable,
the screen information providing device having a recording section capable of recording first electronic information to be transmitted to the communicating terminal and second electronic information to be used in the dialog control device, and being constituted to execute at least one of a processing of transmitting the first electronic information to the communicating terminal and a processing of transmitting the second electronic information to the dialog control device based on the information received from the communicating terminal or the dialog control device,
the dialog control device generating information for a voice dialog based on the second electronic information upon receipt of the second electronic information from the screen information providing device and transmitting the information for a voice dialog to the communicating terminal and transmitting information about a result recognition result to the screen information providing device based on the second electronic information upon receipt of the voice recognition result from the communicating terminal, and
the voice recognizing device being constituted to receive voice information from the communicating terminal, recognize the received voice information, to generate a voice recognition result and to transmits the voice recognition result to the communicating terminal.

7. The dialog system according to claim 6, wherein the communicating terminal is constituted in such a manner that the first electronic information and information obtained by processing the first electronic information can be output upon receipt of the first electronic information from the screen information providing device,
contact input information based on the first electronic information can be transmitted to the screen information providing device when the contact input is carried out,
an input of a voice or an output of the voice can be controlled based on the information for a voice dialog upon receipt of the information for a voice dialog from the dialog control device,
the voice can be transmitted to the voice recognizing device based on the information for a voice dialog when the input of the voice is carried out, and
information about the voice recognition result can be transmitted to the dialog control device based on the information for a voice dialog upon receipt of the voice recognition result from the voice recognizing device.

8. The dialog system according to claim 1, 2 or 6, wherein the dialog control device is constituted to generate information for a voice dialog based on the second electronic information and the voice recognition result upon receipt of the voice recognition result.

9. A dialog system constituted by connecting a screen information providing device to a voice recognizing device and constituted such that a communicating terminal capable of communicating with the screen information providing device and the voice recognizing device can be connected thereto,
the screen information providing device has a recording section capable of recording first electronic information to be transmitted to the communicating terminal and second electronic information to be used in the voice recognizing device,
the first electronic information and the second electronic information are constituted to be transmitted to the communicating terminal based on information received from the communicating terminal, and
the voice recognizing device is constituted to recognize voice information received from the communicating terminal and to generate a voice recognition result of the voice information and is constituted to transmit the voice recognition result to the communicating terminal.

10. The dialog system according to claim 9, wherein the communicating terminal is constituted in such a manner that the first electronic information or information obtained by processing the first electronic information can be displayed upon receipt of the first electronic information from the screen information providing device,
contact input information can be transmitted to the screen information providing device based the first electronic information when the contact input is carried out,
an input of a voice and an output of the voice can be controlled based on the second electronic information upon receipt of the second electronic information from the screen information providing device,
voice information of a voice can be transmitted to the voice recognizing device based on the second electronic information when the voice is input, and
information about a voice recognition result can be transmitted to the screen information providing device based on the second electronic information upon receipt of the voice recognition result from the voice recognizing device.

11. The dialog system according to claim 9, wherein the screen information providing device and the voice recognizing device are connected to each other through a network, and the communicating terminal is constituted to be commutable with the screen information providing device and the voice recognizing device through the network.

12. A dialog control device comprising:
first receiving means for receiving electronic information transmitted from a first electronic computer connected to a network;
generating means for processing the electronic information to generate information for a voice dialog;
first transmitting means for transmitting the information for a voice dialog to a second electronic computer connected to the network and constituted to execute a voice dialog processing;
second receiving means for receiving a voice recognition result generated by a voice dialog processing executed in the second electronic computer; and
second transmitting means for transmitting information about the voice recognition result to the first electronic computer based on the voice recognition result or the electronic information.

13. The dialog control device according to claim 12, wherein the first transmitting means and the second receiving means are constituted by the same first transmitting/receiving means, and the second transmitting means and the first receiving means are constituted by the same second transmitting/receiving means.

14. The dialog control device according to claim 12, wherein the generation of the information for a voice dialog can be executed based on the voice recognition result.

15. A dialog system in which a communicating terminal having a user interface of a contact input, a voice input, a screen display and a voice output can be connected, comprising:
means for receiving electronic information based on the contact input transmitted through the communicating terminal;
means for receiving voice information based on the voice input transmitted through the communicating terminal;
means for transmitting electronic information to be used in the screen display to the communicating terminal;
means for transmitting voice information to be used in the voice output to the communicating terminal, and
means for changing electronic information to be used in the screen display or voice information to be used in the voice output corresponding to electronic information based on the contact input or voice information based on the voice input.

16. A dialog system which is constituted in such a manner that a first communicating terminal having a user interface of a contact input and a screen display can be connected and a second communicating terminal having a user interface of a voice input and a voice output can be connected, the dialog system comprising:
means for receiving electronic information based on the contact input which is transmitted through the first communicating terminal;
means for receiving voice information based on the voice input which is transmitted through the second communicating terminal;
means for transmitting electronic information to be used in the screen display to the first communicating terminal;
means for transmitting voice information to be used in the voice output to the second communicating terminal; and
means for changing voice information to be used in the electronic information based on the contact input or the voice information based on the voice input.

17. The dialog system according to claim 1, 2, 3, 4 or 16, wherein a first user identifier is contact input and transmitted from the first communicating terminal, a second user identifier is transmitted from the second communicating terminal, and the first user identifier is compared with the second user identifier so that the first communicating terminal can correspond to the second communicating terminal.

18. The dialog system according to claim 1, 2, 3, 4 or 16, wherein when the second communicating terminal is connected to the dialog system, first code number data are automatically generated and transmitted to the second communicating terminal in the dialog system,
when the first code number data are output in a voice in the second communicating terminal and the first communicating terminal is then connected to the dialog system, second code number data are contact input from the first communicating terminal and are transmitted to the dialog system, and
the first code number data are compared with the second code number data so that the first communicating terminal can correspond to the second communicating terminal in the dialog system.

19. The dialog system according to claim 1, 2, 3, 4 or 16, wherein when the first communicating terminal is connected to the dialog system, first code number data are automatically generated and transmitted to the first communicating terminal in the dialog system,
when the first code number data are output on a screen in the first communicating terminal and the first communicating terminal is then connected to the dialog system, second code number data are transmitted from the second communicating terminal to the dialog system, and
the first code number data are compared with the second code number data so that the first communicating terminal can correspond to the second communicating terminal in the dialog system.

20. The dialog system according to claim 1, 2, 3, 4 or 16, wherein the first communicating terminal can be connected to a first network to which at least a screen information providing device and the second communicating terminal can be connected to a second network having a plurality of base stations which can communicate with the second communicating terminal and record positional information respectively, and
when the second communicating terminal communicates with a first base station and any communicating terminal which is communicating other than the second communicating terminal is not present in the first base station and when the first communicating terminal is connected to the first network, the first communicating terminal can correspond to the second communicating terminal.
